(19) United States
(12) Patent Application Publication
(10) Pub. No.: US 2024/0346612 A1
(43) Pub. Date: Oct. 17, 2024

(54) System for Simulating, Indexing and Querying Potential Future Scenarios of Real Property

(71) Applicant: Arx City, Inc., Kirkland, WA (US)

(72) Inventors: Hernan Garcia, Kirkland, WA (US); Tomas Garcia, Chicago, IL (US)

(21) Appl. No.: 18/580,347

(22) PCT Filed: Jul. 19, 2022
(86) PCT No.: PCT/US22/37645

§ 371 Date: Jan. 18, 2024

Related U.S. Application Data
(60) Provisional application No. 63/223,463, filed on Jul. 19, 2021.

(51) Int. Cl. G06Q 50/16; G06Q 10/0637; G06Q 30/0201

(52) U.S. Cl. CPC G06Q 50/165; G06Q 10/06375; G06Q 30/0206

(57) ABSTRACT

Disclosed are computerized systems and methods for simulating potential financial outcomes for real property, including determining an acquisition value for an existing property, determine a potential reconfiguration of the existing property; determining a potential value for the property based on the potential reconfiguration; and determining potential financial outcomes for the existing property based on the acquisition values and potential values after potential reconfigurations.

### CROSS REFERENCE TO RELATED APPLICATIONS

This application claims the benefit of priority to U.S. Patent application No. 63/223,463, filed Jul. 19, 2021, the contents of which are incorporated herein by reference in its entirety.

### FIELD OF THE DISCLOSED SUBJECT MATTER

This disclosure relates to systems and methods for analyzing financial opportunities for real estate properties.

### BACKGROUND OF THE DISCLOSED SUBJECT MATTER

The large volume of variables impacting the real estate market prevents professionals in the industry from accurately and efficiently modeling the present value and future potential of a given property. The volume of data is large, the data itself is dynamic across time and geography, and the relevance of the data itself is dynamic across time and geography. This problem ultimately prevents professionals in the industry from deploying capital in an optimal manner.

For a single property, variables include the legal restrictions applicable to a property, costs and time frames for converting a property from current to future configuration, negative cash flows, current property valuation, future valuation, positive cash flows, user-specific assumptions such as cash available, debt financing available, debt financing terms, discount rates, etc. Historically, real estate professionals have relied on external consulting firms, legal counsel, cost-estimators, architects, and past experience to determine variables related to a single property. Obtaining the information for these variables allows a real estate professional to build a financial logic model (typically in a spreadsheet), with the outputs of all of the variables acting as the inputs into the model (one set of inputs per potential project, per property).

The financial logic is determined for a single potential building configuration, on a single property. Due to the complexity of the process, external consultants and other real estate technology companies have focused solely on single-site optimization. That is, a real estate professional indicates a site that they are interested in, then the site is analyzed and a few potential projects are generated. What this means is that it is currently impossible to evaluate capital deployment across an entire real estate market, because the capital deployment analysis begins after a site has already been selected, and the same analysis is not done for non-selected properties.

### SUMMARY OF THE DISCLOSED SUBJECT MATTER

Provided is a system comprising a computerized system with hardware and specialized software components for simulating a potential financial outcome for real property, the system comprising a non-transitory computer readable storage medium comprising a plurality of computer readable instructions embodied thereon which, when executed by the computerized system, causes the computerized system to: determine existing property attributes for an existing property; determine an acquisition value for the existing property based on existing property attributes; and determine a potential financial outcome for the existing property based on existing property attributes and acquisition value.

Embodiments of the system include the following, alone or in any combination.

The system wherein the computer readable instructions further cause the computerized system to determine a potential reconfiguration of the existing property; determine a potential value for the property based on the potential reconfiguration; determine a conversion cost for converting the existing property to the potential reconfiguration; determine a conversion timeline for converting the existing property to the potential reconfiguration; and determine a potential financial outcome for the existing property based on existing property attributes and acquisition value, potential value after potential reconfiguration, conversion cost, and conversion timeline.

The system wherein a plurality of potential reconfigurations of the existing property are determined.

The system wherein conversion costs and conversion timelines for each of the plurality of potential reconfigurations are determined.

The system wherein potential financial outcomes are determined for the plurality of potential reconfigurations of the existing property based on existing property attributes and acquisition value, potential value after each potential reconfiguration, conversion costs and conversion timelines for each potential reconfiguration.

The system wherein the computer readable instructions further cause the computerized system to determine a potential financial outcome for each of a plurality of existing properties based on existing property attributes and acquisition values for each of the plurality of existing properties.

The system wherein a plurality of potential financial outcomes are determined for a plurality of potential reconfigurations of the plurality of existing properties based on existing property attributes and acquisition value, potential value after each potential reconfiguration, and conversion costs and conversion timelines for each potential reconfiguration.

The system further comprising a database configured to store at least one datum for the existing property selected from the group consisting of existing property attributes, acquisition value, potential reconfiguration, potential value, conversion cost, conversion timeline, and potential financial outcome.

The system wherein the database stores a plurality of financial outcomes for a plurality of potential reconfigurations of the existing property.

The system wherein the database stores at least one datum for a plurality of existing properties selected from the group consisting of existing property attributes, acquisition values, potential reconfigurations, potential values, conversion costs, conversion timelines, and potential financial outcomes.

The system further comprising a front-end interface configured to allow a user to search the database.

Also provided is a non-transitory computer readable storage medium comprising a plurality of computer readable instructions embodied thereon wherein the instructions, when executed by a computerized system with hardware and specialized software components for simulating a potential financial outcome for real property, cause the computerized system to: determine existing property attributes for an existing property; determine an acquisition value for the existing property based on existing property attributes; and determine a potential financial outcome for the existing property based on existing property attributes and acquisition value.

Embodiments of the non-transitory computer readable storage medium include the following, alone or in any combination.

The non-transitory computer readable storage medium wherein the instructions further cause the computerized system to determine a potential reconfiguration of the existing property; determine a potential value for the property based on the potential reconfiguration; determine a conversion cost for converting the existing property to the potential reconfiguration; determine a conversion timeline for converting the existing property to the potential reconfiguration; and determine a potential financial outcome for the existing property based on existing property attributes and acquisition value, potential value after potential reconfiguration, conversion cost, and conversion timeline.

The non-transitory computer readable storage medium wherein the instructions further cause the computerized system to determine a plurality of potential reconfigurations of the existing property.

The non-transitory computer readable storage medium wherein the instructions further cause the computerized system to determine conversion costs and conversion timelines for each of the plurality of potential reconfigurations.

The non-transitory computer readable storage medium wherein the instructions further cause the computerized system to determine potential financial outcomes for the plurality of potential reconfigurations of the existing property based on existing property attributes and acquisition value, potential value after each potential reconfiguration, conversion costs and conversion timelines for each potential reconfiguration.

The non-transitory computer readable storage medium wherein the instructions further cause the computerized system to store a plurality of financial outcomes for a plurality of potential reconfigurations of the existing property.

The non-transitory computer readable storage medium wherein the computer readable instructions further cause the computerized system to determine a potential financial outcome for each of a plurality of existing properties based on existing property attributes and acquisition values for each of the plurality of existing properties.

The non-transitory computer readable storage medium wherein a plurality of potential financial outcomes are determined for a plurality of potential reconfigurations of the plurality of existing properties based on existing property attributes and acquisition value, potential value after each potential reconfiguration, and conversion costs and conversion timelines for each potential reconfiguration.

The non-transitory computer readable storage medium wherein the instructions further cause the computerized system to store at least one datum for a plurality of existing properties selected from the group consisting of existing property attributes, acquisition values, potential reconfigurations, potential values, conversion costs, conversion timelines, and potential financial outcomes.

Also provided is a method for simulating a potential financial outcome for real property, executed by a processor of a computerized system comprising a processor and a database, the method comprising the processor: determining existing property attributes for an existing property; determining an acquisition value for the existing property based on existing property attributes; and determining a potential financial outcome for the existing property based on existing property attributes and acquisition value.

Embodiments of the method include the following, alone or in any combination.

The method further comprising determining a potential reconfiguration of the existing property; determining a potential value for the property based on the potential reconfiguration; determining a conversion cost for converting the existing property to the potential reconfiguration; determining a conversion timeline for converting the existing property to the potential reconfiguration; and determining a potential financial outcome for the existing property based on existing property attributes and acquisition value, potential value after potential reconfiguration, conversion cost, and conversion timeline.

The method further comprising the processor storing in the database at least one datum for the existing property selected from the group consisting of existing property attributes, acquisition value, potential reconfiguration, potential value, conversion cost, conversion timeline, and potential financial outcome.

The method further comprising the processor determining a plurality of potential reconfigurations of the existing property; determining conversion costs and conversion timelines for each of the plurality of potential reconfigurations and determining a plurality of potential financial outcomes for the plurality of potential reconfigurations of the existing property based on existing property attributes and acquisition value, potential value after each potential reconfiguration, conversion costs and conversion timelines for each potential reconfiguration.

The method further comprising the processor storing in a database the plurality of financial outcomes for the plurality of potential reconfigurations of the existing property.

The method further comprising the processor determining existing property attributes for each of the plurality of existing properties; determining acquisition values for each of the plurality of existing properties; and determining a plurality of financial outcomes for the plurality of existing properties based on the existing property attributes and the acquisition values for each of the plurality of existing properties.

The method further comprising the processor determining a plurality of potential reconfigurations for each of the plurality of the existing properties; determining conversion costs and conversion timelines for each of the plurality of potential reconfigurations; and determining a plurality of potential financial outcomes for the plurality of potential reconfigurations of the plurality of existing properties based on existing property attributes and acquisition values, potential values after each potential reconfiguration, conversion costs and conversion timelines for each potential reconfiguration.

The method further comprising the processor storing at least one datum for the plurality of existing properties selected from the group consisting of existing property attributes, acquisition values, potential reconfigurations, potential values, conversion costs, conversion timelines, and potential financial outcomes.

Also provided is a system comprising a distributed computerized system with hardware and specialized software components for simulating a potential financial outcome for real property, the system comprising a non-transitory computer readable storage medium comprising a plurality of computer readable instructions embodied thereon which, when executed by the computerized system, causes the computerized system to: store information to a table comprising a first unique identifier (UID) corresponding to each of one or more existing properties in an existing configuration, determine existing property attributes for each existing property in the existing configuration; determine an acquisition value corresponding to the existing property in the existing configuration; store to the table the existing the existing property attributes and the acquisition value associated with the first UID; determine one or more potential reconfigurations of each existing property; storing to the table a second UID corresponding to the one or more potential reconfigurations of the existing property, each second UID associated in the table with a first UID; determining a reconfiguration value corresponding to each of the one or more reconfigurations; store each reconfiguration value to the table associated with each second UID; receive a real estate search request comprising an existing property and one more property attributes; mapping the existing property to the first UID; and generating search results from the table comprising all entries corresponding to the first UID.

Embodiments of this system include any of the previously described embodiments, alone or in any combination.

### BRIEF DESCRIPTION OF THE DRAWINGS

FIG. 1A depicts a schematic functional diagram of a computer system relating to simulating, indexing and querying potential future scenarios for analyzing financial opportunities for real estate properties according to an exemplary embodiment of the disclosed subject matter.

FIG. 1B depicts a schematic functional diagram of a computer system storing data relating to simulating, indexing and querying potential future scenarios for analyzing financial opportunities for real estate properties according to an exemplary embodiment of the disclosed subject matter.

FIGS. 1C through 1E depict a schematic data flow diagram for a computer system relating to simulating, indexing and querying potential future scenarios for analyzing financial opportunities for real estate properties according to an exemplary embodiment of the disclosed subject matter.

FIG. 2 depicts a process flow diagram for a method for analyzing financial opportunities for real estate properties according to an exemplary embodiment of the disclosed subject matter.

FIG. 3 depicts a functional diagram of components of a computer system according to an exemplary embodiment of the disclosed subject matter.

FIGS. 4, 5, 6, 7, 8A and 8B show schematic illustrations of aspects of software architecture according to exemplary embodiments of the disclosed subject matter.

FIGS. 9 through 65 show images of a front-end user interface according to exemplary embodiments of the disclosed subject matter.

### DETAILED DESCRIPTION

The large volume of variables impacting the real estate market prevents professionals in the industry from accurately and efficiently modeling the present value and future potential of a given property. The volume of data is large, the data itself is dynamic across time and geography, and the relevance of the data itself is dynamic across time and geography. This problem ultimately prevents professionals in the industry from deploying capital in an optimal manner.

For a single property, a number of variables need to be determined to assess its value and potential. For instance, the following aspects or steps can be considered.
Step 1. Determining what legal restrictions apply to the property. The most common restrictions are zoning codes (operating at the municipal or county level) and building codes (operating at the municipal, county, or state level). Additionally, there can be other local ordinances or environmental regulations that apply to the property. These legal restrictions dictate the physical configurations that can exist on a site. Historically, real estate professionals have relied on external consulting firms, legal counsel, and past experience in order to review the codes and determine what physical configurations can exist on a site. These forms of review entail manually reviewing the legal codes themselves before proposing configurations that fit within the bounds.
Step 2. Determining how much it costs to convert a property from its current configuration to a new building configuration, or what negative cash flows the project will have. Historically, real estate professionals have relied on external consulting firms, cost-estimators, and past experience in order to calculate the development cost of a potential building configuration. This typically occurs either by using rules of thumb (“it costs $300/sf to build a luxury single family home”) or through more granular estimation. Cost-estimation is done on a case-by-case basis; typically, companies analyze a single potential configuration at a time.
Step 3. Determining how much a property is currently worth. This estimate of the current value of a property in the real estate market is based on existing characteristics, past sales data and comparison to comparable properties. A real estate professional wanting to know how much a property is worth today could use personal experience and/or use an external consultant that is performing a similar type of analysis.
Step 4. Determining how much a property is worth in the future, or what positive cash flows the project will have. Real estate professionals have relied on external consulting firms and past experience in order to estimate what a potential building configuration on a particular property would be worth in the future. A common methodology is to apply a machine learning model such as in the previous step, with predictions for market growth and movements. If the project is intended to be a rental project instead of a for-sale project, the future rents must be estimated in a similar fashion.
Step 5. Determining how long it takes to convert a property from its current configuration to a new building configuration. Historically, real estate professionals have relied on external consulting firms and past experience to estimate the length of development for a potential project.
Step 6. Determining user-specific assumptions such as cash available, debt financing available, debt financing terms, discount rates, etc., done at the user-level. These assumptions often vary according to the outcomes of aspects 1-5. Historically, user-specific assumptions are arrived at through personal experience, though external consulting firms often provide input on what these assumptions should be.
Step 7. Solving all of the prior problems allows a real estate professional to build a financial logic model, typically in a spreadsheet, with the outputs of all of the prior sections acting as the inputs into the model, using one set of inputs per potential project, per property. The purpose of the model is to assess the viability of a potential project on a property. The financial logic model outputs return metrics that allow professionals to compare viability across different projects, in addition to other project variables such as interest expense and leverage effects; calculated recursively through the logic model. Historically, professionals rely on external consultants, or build their own financial logic models to assess project viability.

The process above (aspects 2-7) is delineated for a single potential building configuration, on a single property (step 1 is determining the set of potential building configurations). Due to the complexity of the process, external consultants and other real estate technology companies have focused solely on single-site optimization. That is, a real estate professional indicates a site of interest, then the site is analyzed and a few potential projects are generated. What this means is that it is currently impossible to evaluate capital deployment across an entire real estate market, because the capital deployment analysis begins after a site has already been selected. If a professional analyzes Site A and correctly arrives at the most optimal project for that site, their capital deployment is still sub-optimal if Site B was never even considered and has a substantially better potential project available on it.

The system disclosed herein pre-simulates aspects 1-7 on a recurring basis across every property in a geography and stores the results in an indexed database (referred to herein as the “Megatable”). Professionals are then able to query the Megatable by searching on any or all of the variables or existing attributes that they would be interested in, in addition to all of the variables that can only be derived by performing Steps 1-7 (i.e., return metrics and other project variables). In this way, a professional can accurately and efficiently assess the viability of different potential projects on different properties across an entire geography, and optimally deploy their capital.

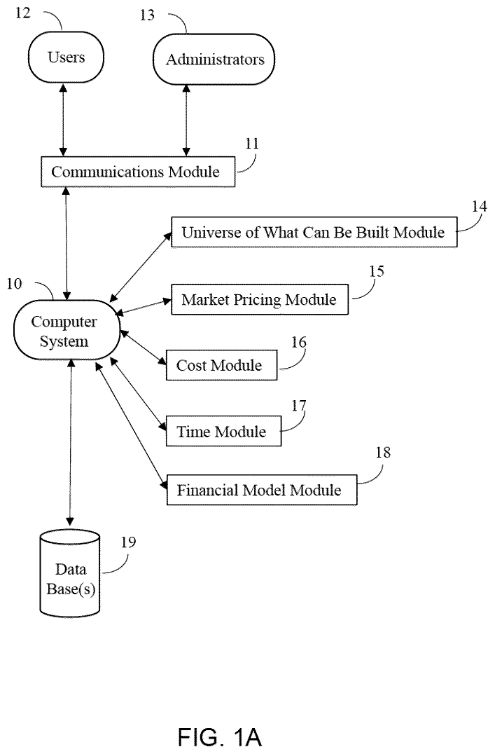

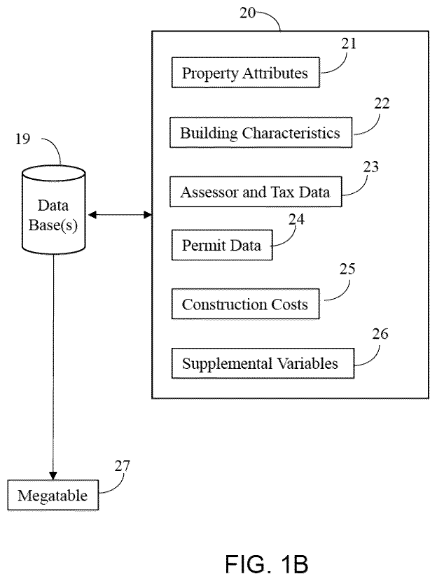

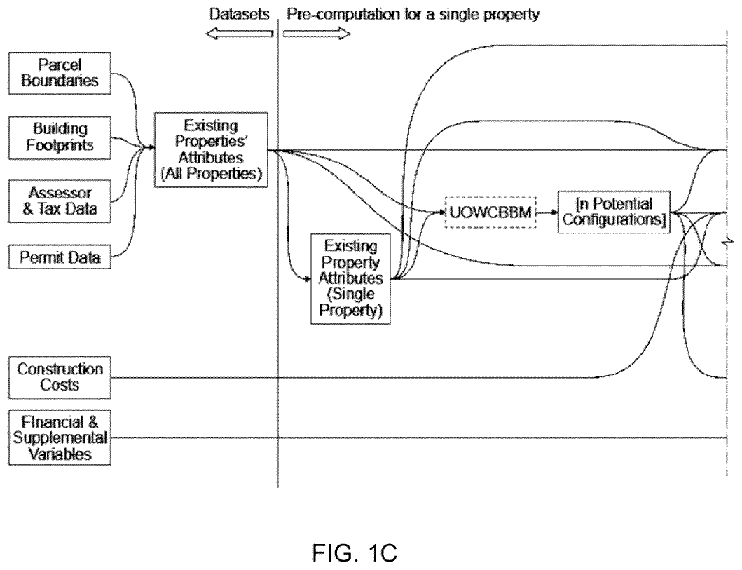

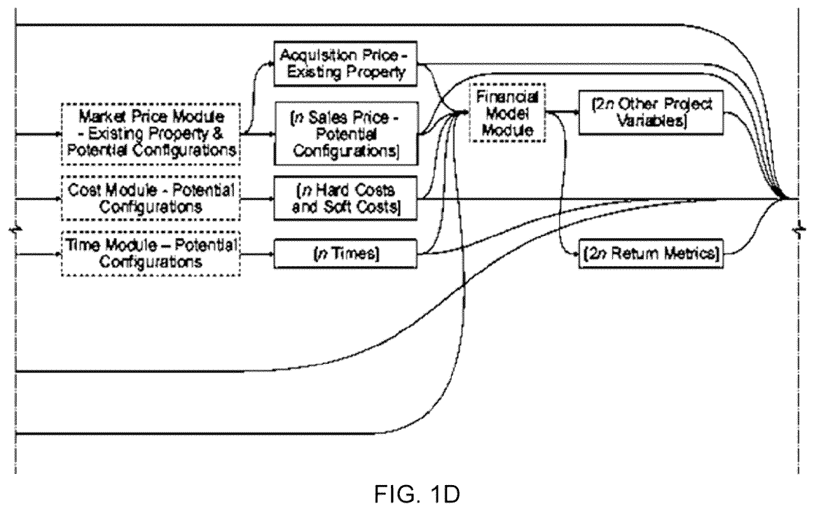

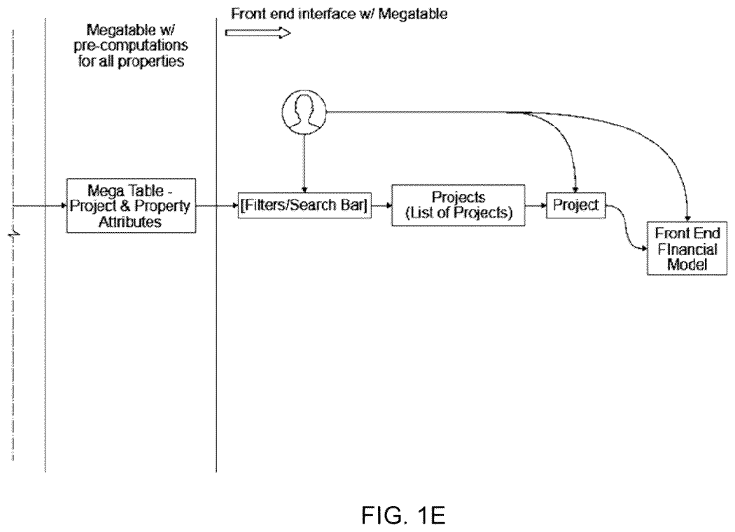

As shown schematically in FIG. 1A, a computer system 10 is the core element of the architecture within the system, receiving, generating, storing, integrating and coordinating data required for receiving inputs from a plurality of users and administrators, determining values for potential property configurations, and outputting data for replying to user queries. The computer system is further provided with at least one processor and into which is loaded software components for operating the system and methods describe herein. The functional architecture of the computer system comprises a number of modules that process data and determine outputs.

As shown in FIG. 1A, the system described herein comprises a series of modules that come together to produce the Megatable described further below. The modules use a number of datasets stored in and retrieved from one or more databases to determine outputs to the Megatable, which stores results from the determinations for processing and interpretation for users to access depending on their search criteria (see FIG. 1B).

### Modules

As shown in FIG. 1A, the computer system 10 comprises several modules.

Block 11 represents a communication or interface module, which manages inputs from, and transmits outputs to, users 12 and administrators 13. Inputs from users 12 include user identity, property investment criteria, user interest in potential property configurations, cost requirement user-specific variables, etc. Communications module 11 may also be used by administrator(s) 13 of the computer system 10 to communicate with the system. Administrator(s) 13 include, for example, representatives of the design and management teams operating the system. Administrator(s) may provide inputs to the system to maintain and manage the system to make sure it is operating correctly. In embodiments, the administrator(s) 13 may also provide or manage information from open source or external proprietary data systems to populate data sets used by the system 10. Communications module 11 provides the front-end interface with the users as shown in FIG. 1E.

The Universe of What Can Be Built Module (UOWCBBM) is shown as block 14. For every given property of real estate, different sets of laws apply. These laws (including Zoning Codes, Building Codes, Environmental Regulations, etc.) vary from municipality to municipality and dictate what can be built on a property of real estate. The UOWCBBM approximates, for any given property, the set of different building configurations that could exist. The UOWCBBM combines multiple ML algorithms, including Linear Regression and K-Nearest Neighbors Regressor, a nearest neighbors' algorithm that for a particular property, takes the County, Municipality, Zone, and Lot Area, and then generates a set of n potential building configurations for a site, based on what types of building configurations are expressed in the existing data on sites that are similarly situated. In embodiments, the capability of the UOWCBB can be augmented by generating potential building configurations for a site by purchasing third party parameterized zoning/building data, where available, and deriving the legal potential building configurations. Many different datasets such as LIDAR 3D imaging, MLS data, etc. could be incorporated and used to refine the existing attribute dataset for model.

The potential building configurations to be generated for each site could be arrived at in a variety of different ways, with differing levels of granularity and accuracy.

In an embodiment, configurations can be based on parameterized zoning and building codes: The zoning and building code parameters, together with their interactions, could be parameterized either manually or through a natural language processing machine learning (ML) model. Those parameters and their interactions could then be used to dictate a set of potential building configurations. This would be the most accurate method of generating the potential building configurations for each site, as every configuration would be certain to be legally allowable.

In an embodiment, potential configurations can be based on machine learned zoning and building codes: A ML model could be applied to the existing property attributes in order to derive the zoning and building code parameters, together with their interactions. Those parameters and their interactions could then be used to dictate a set of potential building configurations. This may be a more accurate method of generating the potential building configurations for each site than the previous embodiment, though there is no guarantee that every configuration would be legally allowable (as zoning codes and building codes change over time, derivations of the codes from the expressed data could be outdated).

Potential configurations can be based on user-provided information. A user could specify a set of potential building configurations for a site. The benefit to user-provided information is that it allows the user to simulate what they think/know to be correct, on every property.

Potential configurations can be based on randomly-generated scenarios. Configurations could be randomly generated for a site. The benefit to randomly generated configurations is that they would capture every single possible building configuration for a site. However, randomly-generated configurations may not be able to differentiate configurations that would likely be practicable based on other considerations such as zoning requirements. This may mean that more configurations than necessary for determining success may be generated.

Hybrid Approach: All of the above methods could be supplemented with additional data, or combined with each other, in order to produce more detailed building configurations. For example, user-provided or randomly-generated configurations could be processed and verified as legally-permissible by processing them using the zoning and building code parameters for the property. Attributes such as building style or architecture type are not necessarily codified, though they impact the cost and value of a given project.

The computer system 10 also comprises Market Pricing Module (MPM) 15. The large volume of dynamic variables impacting real estate valuation makes it difficult to predict what a given building configuration is worth today, and what a potential building configuration could be worth in the future. The MPM predicts (a) the value of any given property of real estate with its current building configuration and (b) the value of any given property of real estate with a different building configuration than the one currently in existence. For example, the module can be used to determine the value of a property at a specific location if converted from a single-family residence to duplex. The MPM comprises two separate models, each handling one of the purposes above. The models are open-source gradient boosting decision trees, which estimate the value of a property of real estate as it currently exists and estimates the value of the property under n scenarios as outputted by the UOWCBB 14. Currently the MPM is driven primarily by the property and building characteristic datasets. In embodiments, incorporating additional datasets can be envisioned in order to increase the accuracy of predictions.

Additionally or alternatively, the MPM may use parameters to refine its predictions.

In embodiments, the MPM could use user-provided information. Users could specify the value of any given property of real estate with its current building configuration. Separately, users could specify the value of any given property of real estate with their estimate of what it would be worth in the future, with a different building configuration. The benefit to user-provided information is that it allows the user to simulate what they think/know to be correct, on every property.

Current and future property values could be randomly generated within ranges. In practice, randomly generated values may be used as a method for generating projects that may not be thought of by professionals with experience bias that could be further analyzed for real world feasibility.

The Cost Module (CM) 16 processes costs associated with the converting the existing property to the potential configurations generated by the UOWCBB 14. Every potential building configuration has an associated cost of construction. Evaluating construction costs across a set of potential building configurations is difficult and time consuming. The CM 16 estimates the cost to configure a property from its existing state to a new potential state. The CM 16 is a logic model, which estimates the constructions costs associated with converting a property from its existing state to the n scenarios as outputted by the UOWCBBM 14. In an embodiment, it may be based on proprietary residential cost logic models along with some supplemental logic models created using unit and assembly data catalogs. In embodiments, additional datasets can be referenced by this module.

In embodiments, the module may comprise machine learning models for cost-prediction instead of logic models. A machine learning model could be used on an underlying source of construction cost data (e.g. building permits data, cost surveys, etc.) in order to assess the price of construction for a given building configuration.

In other embodiments, a user could specify the construction cost for a specified building configuration. This could narrow the number of configurations that need to be fully processed by the system. This could also be used as a filter to select configurations from the Megatable that meet the user's requirements.

Construction costs for a specified building configuration could be randomly generated within ranges. For example, costs could be determined using a random factor to skew a cost determination to simulate an unexpected influence on costs that might impact the financial analysis.

The Time Module (TM) is shown as block 17. Every potential building configuration has an associated development timeline. The timeline is currently subdivided into three phases: designs and approvals, construction, and sales. The TM estimates each of these three phases in order to determine the total length of a potential project, and allocate development expenses and incomes to their corresponding phases. The TM is composed of a Gradient Boosted Decision Tree model, which predicts each one of the timeline phases. In embodiments, additional datasets with more granular phase data can be added, in order to more accurately estimate project length and cost-allocation. In embodiments, expanded machine learning models can incorporate assessor data over time, thus allowing the TM to take into account the effect that existing property attributes may have on development timelines.

In embodiments, users could specify the development timeline for a specified building configuration. This could narrow the number of configurations that need to be fully processed by the system. This could also be used as a filter to select configurations from the Megatable that meet the user's requirements.

In embodiments, a logic-based model could be used on an underlying source of development timeline data (e.g. building permits data, cost surveys, etc.) in order to assess the development timeline for a given building configuration.

Development timelines for a specified building configuration could be randomly generated within ranges to include an unexpected factor in the calculation.

The Financial Model Module (FMM) 18 generates financial outcomes based on data generated by the other modules. Every strategy (buy to sell, build to sell, buy to rent, build to rent, etc.) and asset type (small-scale residential [1-4 unit buildings], residential, commercial, industrial, etc.) requires a custom-built financial logic model. In embodiments, the strategies may each comprise one or more sub-strategy (as-of-right, variance, sub-division of larger lots, aggregation of smaller lots, portfolio project (i.e. assembling a portfolio of disparate properties), portfolio optimization (i.e. entering a list of properties and optimizing a capital deployment across those properties)). Each one of these models must be able to make unlevered projections (without debt) and levered projections (with debt). A financial model ultimately serves to “map” out a potential project's cash flows over time in order to discount them back to present in the form of a return metric, such as Internal Rate of Return (IRR). The FMM processes the outputs of the MPM, the CM, the TM, along with the SV, in order to produce a set of “Return Metrics” and a set of “Other Project Variables” for each potential project. “Return Metrics” include standard financial analysis metrics such as IRR and Profit, on both an unlevered and levered basis. “Other Project Variables” include values such as Before Tax Cash Flows or Interest Expense that are displayed to the user. The FMM is a logic model.

In Build to Sell and Buy to Sell strategies, the financial analyses are directed toward scenarios in which the existing property is acquired and then sold to realize a financial gain. The time period for these strategies may be considered as approximately the time to go through the project design and permitting process, the reconfiguration timeline, plus a period of time allocated to selling the property after reconfiguration. These strategies can encompass As-of-right, Variances, and sub-division sub-strategies among others.

In these embodiments, the system will determine existing property attributes for an existing property; determine an acquisition value for the existing property based on existing property attributes; determine a potential reconfiguration of the existing property, if applicable; determine a potential value for the property based on the potential reconfiguration, if applicable; determine a conversion cost for converting the existing property to the potential reconfiguration, if applicable; determine a conversion timeline for converting the existing property to the potential reconfiguration, if applicable; and determine a potential financial outcome for the existing property based on existing property attributes and acquisition value, potential sales value after potential reconfiguration, if applicable, conversion cost, if applicable, and conversion timeline, if applicable.

In Build to Rent and Buy to Rent strategies, the financial analyses are directed toward scenarios in which the existing property is acquired and held and the financial outcomes are based on ongoing rental or lease payments to realize a financial gain. The financial outcomes may be determined based on varied period(s) of time in which the payments are received. These strategies can encompass As-of-right, Variances, and sub-division sub-strategies among others.

In these embodiments, the system will determine existing property attributes for an existing property; determine an acquisition value for the existing property based on existing property attributes; determine a potential reconfiguration of the existing property, if applicable; determine a potential rental value for the property based on the existing property attributes; determine a potential rental value for the property based on the potential reconfiguration, if applicable; determine a conversion cost for converting the existing property to the potential reconfiguration, if applicable; determine a conversion timeline for converting the existing property to the potential reconfiguration, if applicable; and determine a potential financial outcome for the existing property based on existing property attributes and acquisition value, potential rental value for the property based on the existing property attributes, potential rental value after potential reconfiguration, if applicable, conversion cost, if applicable, and conversion timeline, if applicable.

In Aggregation of Smaller Lots strategies, the system determines financial outcomes based on acquiring an existing property and combining it with one or more additional properties, which may or may not be already be already acquired. The aggregation may be combining adjacent properties, or may be combining non-adjacent properties that have similar attributes.

In Aggregation of Smaller Lots Build to Sell and Buy to Sell strategies, the financial analyses are directed toward scenarios in which the existing property and additional properties are acquired and then sold to realize a financial gain. The time period for these strategies may be considered as approximately the time to go through the project design and permitting process, the reconfiguration timeline, plus a period of time allocated to selling the property after reconfiguration. These strategies can encompass As-of-right, Variances, and sub-division sub-strategies, among others.

In these embodiments, the system will determine existing property attributes for both an existing property and additional properties; determine an acquisition value for the existing property and additional properties based on existing property attributes of both existing property and additional properties; determine a potential reconfiguration of the existing property and additional properties, if applicable; determine a potential value for the property based on the potential reconfiguration, if applicable; determine a conversion cost for converting the existing property and additional properties to the potential reconfiguration, if applicable; determine a conversion timeline for converting the existing property and additional properties to the potential reconfiguration, if applicable; and determine a potential financial outcome for the existing property and additional properties based on existing property attributes and additional property attributes and acquisition value, potential sales value after potential reconfiguration, if applicable, conversion cost, if applicable, and conversion timeline, if applicable.

In Aggregation of Smaller Lots Build to Rent and Buy to Rent strategies, the financial analyses are directed toward scenarios in which the existing property and additional properties are acquired and held and the financial outcomes are based on ongoing rental or lease payments to realize a financial gain. The financial outcomes may be determined based on varied period(s) of time in which the payments are received. These strategies can encompass As-of-right, Variances, and sub-division sub-strategies, among others.

In these embodiments, the system will determine existing property attributes for both an existing property and additional properties; determine an acquisition value for the existing property and additional properties based on existing property attributes of both existing property and additional properties; determine a potential reconfiguration of the existing property and additional properties, if applicable; determine a potential rental value for the property based on the existing property attributes of both existing property and additional properties; determine a potential rental value for the property based on the potential reconfiguration, if applicable; determine a conversion cost for converting the existing property and additional properties to the potential reconfiguration, if applicable; determine a conversion timeline for converting the existing property and additional properties to the potential reconfiguration, if applicable; and determine a potential financial outcome for the existing property and additional properties based on existing property attributes and additional property attributes and acquisition value, potential rental value for the property based on both the existing property attributes of both existing property and additional properties, potential rental value after potential reconfiguration, if applicable, conversion cost, if applicable, and conversion timeline, if applicable.

In Portfolio Optimization strategies, analyses are conducted for a group of properties to determine financial outcomes for each property and the outcomes are compared to determine which properties provide higher financial returns. For a user-specified list of properties (portfolio) and user-specified list of financial constraints such as time, capital, financial return metrics, the system may conduct all of the aforementioned analyses to determine the profit-maximizing allocation of user-resources across the portfolio. It can be appreciated that the allocation of resources across a portfolio may mean that the profit potential of any one property is not maximized, but the profit potential of the aggregate of properties within the portfolio is maximized.

For illustration of how the financial analyses are conducted, in one embodiment, the FMM may determine outputs for a Build to Sell strategy, as-of-right sub-strategy, and small-scale residential asset types. If the UOWCBBM generates n potential configurations for a property, the FMM may generates 2n outputs per property (unlevered and levered). The FMM is implemented in Python, which allows gains in efficiency over traditional logic models implemented in spreadsheets. In other embodiments, the system is expandable to add additional financial models for all of the different permutations of strategy, sub-strategy, and asset type.

While the example embodiment of the FMM generates 2n outputs per property, in other embodiments, the n multiplier could be greatly expanded as more robust sensitivity analysis is run across different variables (for example, pre-simulating an all-else-equal project while varying the construction interest rate alone). In this manner the system can expand the indexable project variables that a user could search for a particular query.

While an embodiment of the FMM comprises a logic model, in other embodiments, a machine learning (ML) module could be deployed on an underlying dataset composed of the inputs and outputs of the FMM. The ML model could be trained to predict the outputs of the FMM, without needing to go through the logic calculations. This approach would require a dataset of already existing pre-simulations in order to train the machine learning model, so this could be considered an optimization technique.

FIG. 1A also shows schematically that the computer system 10 is in communication with one or more databases 19. As shown in FIG. 1B, the databases store data used by and produced by the system 10. Database(s) 20 store datasets used as inputs by the modules of the system to carry out the methods described herein. All of the disparate open source and proprietary datasets described below are ingested, enriched, and joined, forming the underlying “starting point” for the modules to work from. The system is data agnostic; there are multiple different providers of real estate data in the market. The system comprises for example, datasets from external providers, which in turn are populated with data from various sources. The system is not limited to the specific datasets listed in the following examples, but the types of data described for each dataset are used in the determinations of the modules of the system.

Datasets may include the following:

Dataset 21 is a dataset of property attributes. The dataset contains information on existing lot characteristics (such as lot dimensions, geographic coordinates, etc.) and may also include some elements of laws that apply to properties (the zoning of the property, the existing land-use of the property, allowable building envelope, etc.). The dataset 21 may be compiled from municipal recorder and deed data, zoning maps, open source mapping, etc. collected on an ongoing or periodic, such as monthly, basis. The system may ingest property boundaries at the county level. Each county releases its own dataset, which the system integrates into the dataset. In embodiments, property boundaries may be obtained from a third party provider who downloads information from governing entities such as counties or municipalities. It can be appreciated that property boundaries are relatively static over time, so there may be limited changes in the dataset for some aspects of the property.

The Building Characteristics dataset 22 relates to existing building characteristics (footprint, gross living area, number of parking spots, architecture type, building quality, etc.) and may be obtained from municipal records, prior sales information, open source mapping, etc.

The Assessor and Tax dataset 23 contains information related to historical value assessments and tax assessments of the property as determined by governing entities.

The Building Permit dataset 24 contains information on building permits, including their filing timelines, the contemplated work, and their stated value. The data may be updated on a periodic, such as monthly, basis.

The Construction Costs dataset 25 covers construction cost data, which can include itemized construction cost data at a unit or assembly level and/or estimates based on residential construction cost logic models, which generate cost-estimates, at the building component level, for a given building configuration. The construction costs can include hard costs and soft costs.

Financial and Supplemental Variables (SV): The SV dataset 26 supplies the inputs necessary for financial modeling, which are otherwise unavailable from the other datasets. Every variable in the SV could be replaced in the future by adding additional datasets and training variable-specific ML models on those datasets. For example, the construction loan interest rate could be predicted through an analysis of a bank's construction loan database.

In embodiments, any and all other variables necessary as inputs for a financial logic model could be randomly generated. For example, variables for interest rates, amortization schedules, etc. could be randomly-generated from within a set of ranges derived from historical data, predictions of future values, etc.

In embodiments, a machine learning model could be used on an underlying data set for supplemental variables (e.g. for the supplemental variable of Construction Loan Interest Rate; an ML model could be deployed on historical construction loan rates) in order to provide a prediction for an element. Machine learning models may comprise neural networks.

The system aggregates data from one or more of the datasets described to define existing property attributes for each property analyzed by the system that are used by the modules described above.

FIG. 1B also shows that the databases comprise the Megatable 27. The Megatable 27 is the database where all outputs from every module are appended and stored. For every property in the Megatable 27, the system automatically appends and attaches every corresponding relevant variable from the disparate datasets to build a complete picture of a property as it exists today. As the property is processed in each one of the modules, the Megatable 27 is appended and updated with each modules' set of outputs. In embodiments, for every property in the Megatable, there will be 2n simulated future potential projects that are searchable by the user.

The pre-computed Megatable could be generated at varying levels of granularity. The key with the Megatable is that it can be generated with as many variables or as few variables as wanted. For example, running solely the UOWCBB alone would yield a Megatable where potential future building configurations for a site could be searched for (based on potential future characteristics, instead of past characteristics). For example, the user could search for a potential configuration Build-to-Sell, As-of-Right, Small-Scale Residential asset without consideration of how the property is currently configured. The user could then review the assets with that configuration reported from the Megatable and select properties that meet user needs.

Alternatively, the Megatable could be searched on user-filtered variables, such as location, purchase price, construction costs, construction timelines, IRR, etc. based on what variables are most important to the user. The Megatable includes all of the future property characteristics that real estate professionals care about.

In embodiments, a machine learning module can be trained on top of the Megatable, allowing for optimizing the process and further enriching the Megatable. Layering a machine-learning model on top of the Megatable may allow for partially or fully eliminating the logic model approach, providing further gains in efficiency. For example, a machine learning model may comprise a hybrid element dynamically updating and testing different project scenarios as a user inputs search criteria.

### Backend Process Flow (Diagram)

With reference to FIGS. 1C through 1E, the following description illustrates the Backend Process Flow diagram, which outlines the system's process for a single property, using the example of a Build-to-Sell strategy, As-Of-Right sub-strategy, Small-Scale Residential asset type. The Megatable is generated by running this process for every property within a given geography. For every property, the process can be repeated for each permutation of Strategy/Sub-Strategy/Asset Type, in order to fully capture the universe of potential future projects. The process for these other permutations is similar, so descriptions of the process for other permutations is not included herein for simplicity of presentation.

### Process Data Flow

The process starts in FIG. 1C with datasets such as described above that provide input into the system. Step 1. Datasets of Existing Property Attributes (for a single property) are collected or retrieved from primary sources such as maps, deeds, tax data, assessments, third-party providers, etc. Existing Property Attributes can include for example, parcel (lot) boundaries, building footprints, assessor and tax data, and permit data.
Step 2. The Existing Property Attributes (for a single property) are processed by the UOWCBBM, together with Existing Properties' Attributes (for all properties in a geographic region). A set of n potential configurations are generated (n can be influenced by adjusting the number of variables considered as relevant. For example, the system can be configured to include or exclude basements. The step-sizes of each of the variables can be considered and adjusted.
Step 3. Next, in FIG. 1D, the property is processed by the MPM to produce or determine a corresponding Acquisition Price for the existing property. The MPM inputs include the Existing Property Attributes and the n potential configurations generated by the UOWCBBM.
Step 4. (FIG. 1D) Each Potential Configuration is processed by the MPM in order to produce a set of n Sales Prices. The Sales Price corresponds to the value of the property post-reconfiguration.
Step 5. (FIG. 1D) The Existing Property Attributes and each Potential Configuration generated by the UOWCBBM are processed by the CM in order to produce a set of n Hard Costs and Soft Costs. Inputs for the CM include datasets related to construction costs (FIG. 1C). The Hard Costs are a measure of how much direct construction cost is associated with converting a property from its original state into a new potential configuration, while Soft Costs are a measure of incidental or related expenses. Costs can include values for demolition, remodeling, (re) construction, new equipment, fees such as architectural, permit and assessor fees, etc.
Step 6. (FIG. 1D) The Existing Property Attributes and each Potential Configuration are processed by the TM in order to produce a set of n Times. The Times are a measure of how many months of work are associated with converting a property from its original state into a potential configuration. As described above, the times can include pre-construction, construction and post-construction phases. It can be appreciated that the Times may have an influence on the financials of a venture in terms of opportunity costs, carrying costs, etc.
Step 7. (FIG. 1D) The outputs of the MPM, the CM, and the TM, in addition to the contents of the SV datasets (FIG. 1C), are the inputs for the FMM. The FMM simulates each Potential Configuration with debt and without debt, resulting in 2n output scenarios. The FMM calculates and outputs a set of Return Metrics for every scenario, in addition to Other Project Variables.

Steps 1-7 are performed for every single property in the database relevant to a particular geographic region, property type, etc. As a property is processed by each module, the resulting outputs are logged and stored as a potential future scenario for a property.

The Megatable (FIG. 1E) is where all of the potential future scenarios for every property are stored. For example, 123 Alphabet Lane and all of its associated existing property data are stored in the Megatable prior to the backend process. As 123 Alphabet Lane is processed, the Megatable is appended to include each and every future simulation of 123 Alphabet Lane that the system's modules produce and predict.

FIG. 1E also shows schematically the frontend user interface that allows users to interact with the system to analyze and prioritize potential projects in which to invest. The frontend interface allows a user to search the Megatable for properties. It also comprises a frontend financial module that allows a user to input and adjust financial variables to be used by the FMM to determine financial outcomes for their selected properties. Projects for a given user can be linked to the user and saved in a database.

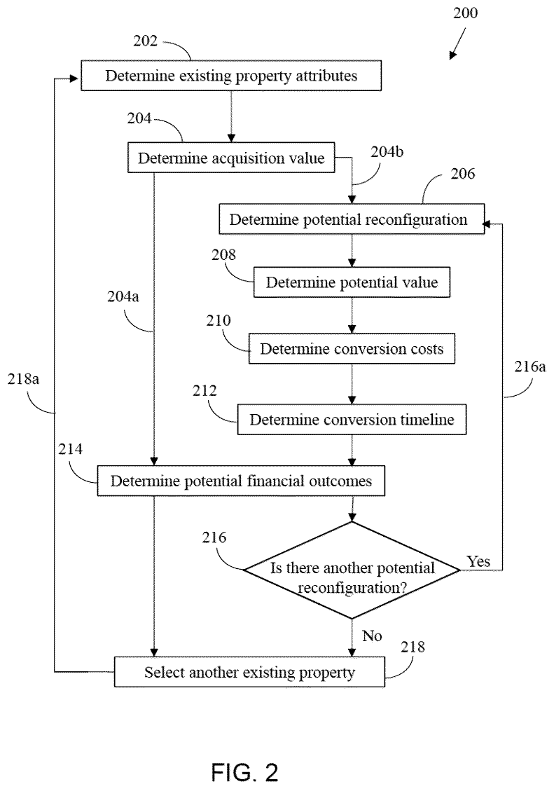

FIG. 2 depicts a process flow diagram for a method for analyzing financial opportunities for real estate properties carried out by the computer system according to an aspect of the present disclosure. As described herein, and shown in block 202, a processor in the computer system determines existing attributes for an existing property. The attributes can be determined using datasets of information obtained from open sources or proprietary providers as described above.

As shown in block 204, a processor operating in the Market Pricing Module determines an acquisition value for the existing property based on the existing property attributes by comparing the attributes to attributes of other properties in the market and applying market-based value for attributes as described above.

The processor continues via arrow 204a to block 214 to determine financial outcomes for the property based on its existing property attributes and acquisition value where no reconfiguration is required. This part of the process may be used for Buy to Rent strategies, wherein the property may be acquired and held, with future income derived from rental or lease payments.

Financial outcomes may include one or more financial metrics including, but not limited to, unlevered profit, unlevered internal rate of return (IRR), levered profit, levered IRR, levered Equity Multiple, return on investment (ROI), return on capital (ROC), gross multiple of invested capital (MOIC) and capitalization rates (cap rates), among others.

The processor may also continue via arrow 204b to block 206 to determine a potential reconfiguration for the existing property.

As shown in block 206, a processor operating in the UOWCBBM determines a potential reconfiguration for the existing property as described above, using the datasets described above to define a potential reconfiguration of assets on the existing property. As used herein, a simple reconfiguration may include basic repairs, maintenance and/or redecorating a building to make an existing property more desirable to occupy. More complex reconfigurations may include renovating or remodeling an existing building on the property, tearing down an existing building and constructing a new building, etc. In some embodiments, a reconfiguration may comprise aggregating two or more properties into a larger property for a potential redevelopment. The processor defines a set of potential attributes based on the potential reconfiguration using the datasets described above. This part of the process may be used for Buy to Sell strategies wherein a property may be acquired, reconfigured or remodeled, and subsequently sold (often referred to as “flipping”). It may also be used for Buy, Reconfigure and Hold (Rent) strategies, wherein the reconfigured property is held and future income is derived from rental or lease payments. The processor then moves to block 208.

In block 208, the processor operating in the Market Pricing Module determines a potential value for the property based on the potential reconfiguration and the potential attributes determined in the UOWCBBM. The processor then moves to block 210.

In block 210, a processor operating in the cost module determines cost(s) for converting the existing configuration of the existing property to the potential reconfiguration determined by the UOWCBBM, using the existing and potential attributes and cost estimations from cost estimating data sets as described above. The processor then moves to block 212.

In block 212, a processor operating in the time module determines a timeline for converting the existing configuration of the existing property to the potential reconfiguration determined by the UOWCBBM, using the existing and potential attributes and estimations from timeline estimating data sets as described above.

It can be appreciated that steps of the process flow in blocks 208, 210 and 212 need not be conducted in the order shown in FIG. 2 and can be carried out sequentially and/or simultaneously in any order.

In block 214, a processor operating in the financial model module determines a financial outcome for the potential reconfiguration. The financial model module bases the financial outcome on the outputs of the market price module, cost module and time module together with existing property attributes, potential property attributes after reconfiguration, financial variables and supplemental variables. In general, the difference between the acquisition value and the potential sale value of the potentially reconfigured property is considered as a positive input to the financial model, while costs are considered as negative inputs to the financial model. Positive and negative inputs to the model are discounted over time to determine time-weighted return metrics.

In block 216, a processor in the computer system determines whether an additional reconfiguration was, or can be, determined by the UOWCBBM. If additional reconfigurations are available, the computer system returns to block 206 (arrow 216a) to process an additional reconfiguration. If additional reconfigurations are not available, the computer system proceeds to block 218.

After all financial outcomes including outcomes based on no reconfiguration and on all potential reconfigurations determined in the UOWCBBM for the existing property have been processed through block 214, the computer system selects another existing property in block 218 and returns to block 202 (arrow 218a) to process that property.

Although not shown in FIG. 2, it can be appreciated that data from any and all of the steps shown in FIG. 2 can be stored in a database (i.e. the Megatable as described herein) as part of the process.

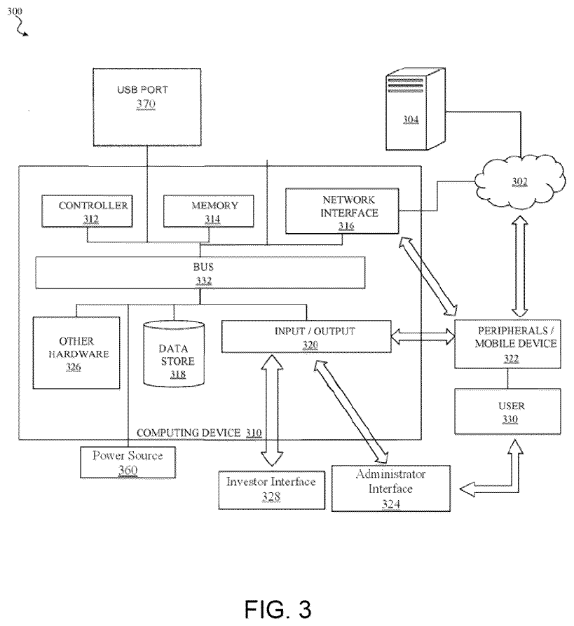

FIG. 3 depicts a computer system 300 according to an embodiment of the present disclosure. In general, the computer system 300 may include a computing device 310, such as a special-purpose computer designed and implemented for receiving user inputs, determining and directing and controlling the output of signals. The computing device 310 may be or include data sources, client devices, and so forth. In certain aspects, the computing device 310 may be implemented using hardware or a combination of software and hardware. The computing device 310 may be a standalone device, a device integrated into another entity or device, a platform distributed across multiple entities, or a virtualized device executing in a virtualization environment.

The computing device 310 may communicate across a network 302. The network 302 may include any data network(s) or internetwork(s) suitable for communicating data and control information among participants in the computer system 300. This may include public networks such as the Internet, private networks, and telecommunications networks such as the Public Switched Telephone Network or cellular networks using cellular technology and/or other technologies, as well as any of a variety other local area networks or enterprise networks, along with any switches, routers, hubs, gateways, and the like that might be used to carry data among participants in the computer system 300. The network 302 may also include a combination of data networks and need not be limited to a strictly public or private network.

The computing device 310 may communicate with an external device 304. The external device 304 may be any computer, mobile device such as a cell phone, tablet, smart watch or other remote resource that connects to the computing device 310 through the network 302. This may include any of the servers or data sources described herein, including servers, content providers, databases or other sources for shot information to be used by the devices as described herein.

In general, the computing device 310 may include a controller or processor 312, a memory 314, a network interface 316, a data store 318, and one or more input/output interfaces 320. The computing device 310 may further include or be in communication with peripherals 322 and other external input/output devices that might connect to the input/output interfaces 320.

The controller 312 may be implemented in software, hardware or a combination of software and hardware. According to one aspect, the controller 312 may be implemented in application software running on a computer platform. Alternatively, the controller 312 may include a processor or other processing circuitry capable of processing instructions for execution within the computing device 310 or computer system 300. The controller 312, as hardware, may include a single-threaded processor, a multi-threaded processor, a multi-core processor and so forth. The controller 312 may be capable of processing instructions stored in the memory 314 or the data store 318.

The memory 314 may store information within the computing device 310. The memory 314 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 314 may store program instructions, program data, executables, and other software and data useful for controlling operation of the computing device 310 and configuring the computing device 310 to perform functions for a user 330. The memory 314 may include a number of different stages and types of memory for different aspects of operation of the computing device 310. For example, a processor may include on-board memory and/or cache for faster access to certain data or instructions, and a separate, main memory or the like may be included to expand memory capacity as desired. All such memory types may be a part of the memory 314 as contemplated herein.

The memory 314 may, in general, include a non-volatile computer readable medium containing computer code that, when executed by the computing device 310 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 314 is depicted, it will be understood that any number of memories may be usefully incorporated into the computing device 310.

The network interface 316 may include any hardware and/or software for connecting the computing device 310 in a communicating relationship with other resources through the network 302. This may include remote resources accessible through the Internet, as well as local resources available using short range communications protocols using, e.g., physical connections (e.g., Ethernet), radio frequency communications (e.g., Wi-Fi, Bluetooth), optical communications (e.g., fiber optics, infrared, or the like), ultrasonic communications, or any combination of these or other media that might be used to carry data between the computing device 310 and other devices. The network interface 316 may, for example, include a router, a modem, a network card, an infrared transceiver, a radio frequency (RF) transceiver for receiving AM/FM or satellite radio sources, a near field communications interface, a radio-frequency identification (RFID) tag reader, or any other data reading or writing resource or the like.

The network interface 316 may include any combination of hardware and software suitable for coupling the components of the computing device 310 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 302 such as the Internet. This may also include hardware/software for a WiMax connection or a cellular network connection (using, e.g., CDMA, GSM, LTE, or any other suitable protocol or combination of protocols). The network interface 316 may be included as part of the input/output devices 320 or vice-versa.

The data store 318 may be any internal or external memory store providing a computer-readable medium such as a disk drive, an optical drive, a magnetic drive, a flash drive, or other device capable of providing mass storage for the computing device 310. The data store 318 may store computer readable instructions, data structures, program modules, and other data for the computing device 310 or computer system 300 in a non-volatile form for relatively long-term, persistent storage and subsequent retrieval and use. For example, the data store 318 may store an operating system, application programs, program data, databases, files, and other program modules or other software objects and the like. In particular, the data store may store existing property attributes and/or potential configurations generated by the system in the Megatable. Although a single data store 318 is shown, a plurality of data stores 318 storing different data used or generated by the system.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

The input/output interface 320 may support input from and output to other devices that might couple to the computing device 310. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also include an infrared interface, RF interface, magnetic card reader, or other input/output system for wirelessly coupling in a communicating relationship with other local devices. It will be understood that, while the network interface 316 for network communications is described separately from the input/output interface 320 for local device communications, these two interfaces may be the same, or may share functionality, such as where a USB port 370 is used to attach to a Wi-Fi accessory, or where an Ethernet connection is used to couple to a local network attached storage. The input/output interface 320 may further output signals to displays of peripheral devices, as described herein.

As used herein, a user 330 is any human that interacts with the computer system 300. In this context, a user may be generally classed within one of two categories, as described above. One category is an administrator of the system. Another category is a real estate professional or investor who wishes to perform property analyses for potential investment scenarios.

In certain embodiments the I/O interface 320 facilitates communication with input and output devices for interacting with a user. For example, the I/O interface may communicate with one or more devices such as a user-input device and/or a display 350 which may be instantiated on the device described herein or on a separate device such as a mobile device 208, which enable a user to interact directly with the controller 312 via bus 332. The user-input device may comprise one or more push-buttons, a touch screen, or other devices that allows a user to input information. In these embodiments, the computer system may further comprise a display to provide visual output to the user. The display may comprise any of a variety of visual displays, such as a viewable screen, a set of viewable symbols or numbers, and so on. One can appreciate that the inputs and outputs of the computer system would be different for administrators and real estate users. Accordingly, the computing device 310 may communicate with administrators and real estate users with different interfaces 324 and 328. Specifically, administrators may need to access parts of the system that relate to operation of the system as a whole, wherein real estate users may be allowed access only to aspects of the system related to user queries and outputs from the Megatable. In embodiments, the User interface 328 may comprise an app downloaded to a mobile device such as a smart phone, tablet, etc. or a personal computer.

A peripheral 322 may include any device used to provide information to or receive information from the computing device 310. This may include human input/output (I/O) devices such as a keyboard, a mouse, a mouse pad, a track ball, a joystick, a microphone, a foot pedal, a camera, a touch screen, a scanner, or other device that might be employed by the user 330 to provide input to the computing device 310. This may also or instead include a display, a printer, a projector, a headset or any other audiovisual device for presenting information to a user. The peripheral 322 may also or instead include a digital signal processing device, an actuator, or other device to support control of or communication with other devices or components. In one aspect, the peripheral 322 may serve as the network interface 316, such as with a USB device configured to provide communications via short range (e.g., Bluetooth, Wi-Fi, Infrared, RF, or the like) or long range (e.g., cellular data or WiMax) communications protocols. In another aspect, the peripheral 322 may augment operation of the computing device 310 with additional functions or features, or other devices. In another aspect, the peripheral 322 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 310 may be used as a peripheral 322 as contemplated herein.

Other hardware 326 may be incorporated into the computing device 310 such as a co-processor, a digital signal processing system, a math co-processor, a graphics engine, a video driver, a camera, a microphone, additional speakers, and so forth. The other hardware 326 may also or instead include expanded input/output ports, extra memory, additional drives, and so forth.

A bus 332 or combination of busses may serve as an electromechanical backbone for interconnecting components of the computing device 310 such as the controller 312, memory 314, network interface 316, other hardware 326, data store 318, and input/output interface. As shown in the figure, each of the components of the computing device 310 may be interconnected using a system bus 332 in a communicating relationship for sharing controls, commands, data, power, and so forth.

The computing device 310 is connected to a power source 360 to provide electrical power for the computing device to run.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module herein, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

The computer program controls input and operation of the device. The computer program includes at least one code segment stored in or on a computer-readable medium residing on or accessible by the device for instructing the computing elements, and any other related components to operate in the manner described herein. The computer program is preferably stored within the memory and comprises an ordered listing of executable instructions for implementing logical functions in the device. However, the computer program may comprise programs and methods for implementing functions in the device that are not an ordered listing, such as hard-wired electronic components, programmable logic such as field-programmable gate arrays (FPGAs), application specific integrated circuits, or other similar or conventional methods for controlling the operation of electrical or other computing devices.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. The computer-readable medium may even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The Data processing infrastructure architecture for processing data is broken out into 5 data flows, in order: data ingestion, staging pipeline, machine learning input pipeline, output pipeline, and upload pipeline.

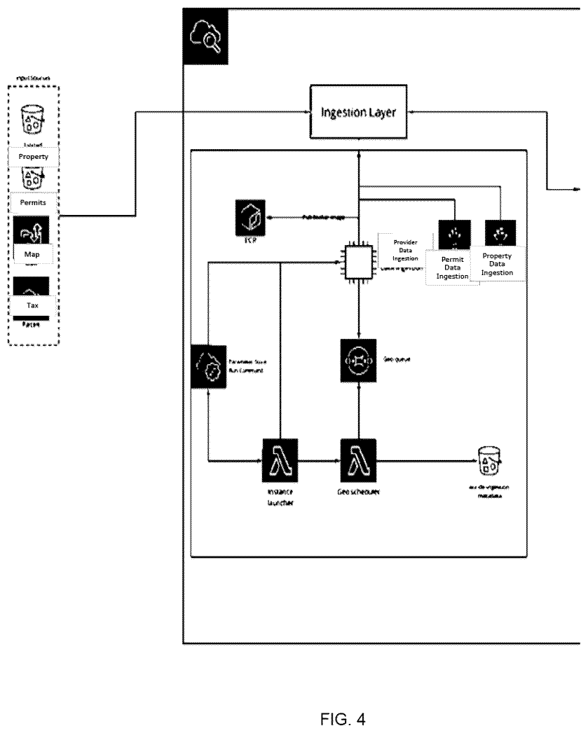

FIG. 4 shows an architecture for the system to ingest data from multiple spatial data sources. Data Ingestion includes several jobs that transfer data from external open source or proprietary providers to raw data buckets. At this stage, no processing is applied to any dataset; the data source is extracted as it is and transferred to specific buckets that correspond to the data providers. For example, datasets may contain information about spatial location of properties. Other data may contain information about points of interest (POI) such as restaurants, shopping, trees, atm's, lakes, buildings, local, state and national parks, etc. that may facto in the desirability of an existing property and increase its value. The data from various sources may not be mutually compatible, so it may be necessary to convert the data into a common format.

The architecture for doing this comprises components that work together as a service: Queue messaging system, EC2 machine with running docker process, SSM Parameter Store, SSM Run Command and Lambda functions. The First lambda function Instance Launcher is responsible for running EC2 instance and sending commands to execute them on previously launched EC2 machine and obtain parameters from SSM Parameter Store. Based on the obtained parameters, it executes commands on EC2 via SSM Run Command to invoke the Geo scheduler lambda function. The Second lambda geo scheduler is responsible for getting metadata of ingested sources from the metadata-ingestion bucket (data source name, source url, destination bucket, geographic region, etc), creating messages based on this metadata and sending them to Queue Service. Once EC2 machine is turned on, and commands are received. It downloads the latest version of docker image from ECR repository (this image is built in the service repository and deployed to ECR where it contains logic to ingest data) and run a run downloaded container with parameters obtained from SSM Parameter Store. The service starts listening to Queue service and once new message is received it process the data and put them to a raw data s3bucket.

Based on this solution, it is possible to service all types of spatial data and write them in WKT format. It was needed to build a custom service because of different data formats (.pdf, GeoJSON, WKT, shp), and tools (GDAL, osgeo), that do not integrate with serverless solutions well.

The Staging pipeline produces several datasets from the ingested data. Most of the data comes in flat file; flat files are not compressed at all and do not contain schema of data. It is desirable to gather all the raw data sources and group by specific category, to improve the performance in further transformations and aggregations. Cleaning and transforming comprise formatting the data into a consistent format and aggregating and structuring the data to a unique key. For example, location data may be identified by county and parcels in the county. With that transformation, each record is unique. With that aggregation, every data source has the same unique key that identifies row, and their other dimensions are stored in aggregated column. Data structuring provides that the rest of the sources are transformed by grouping fields of the same category into one structure.

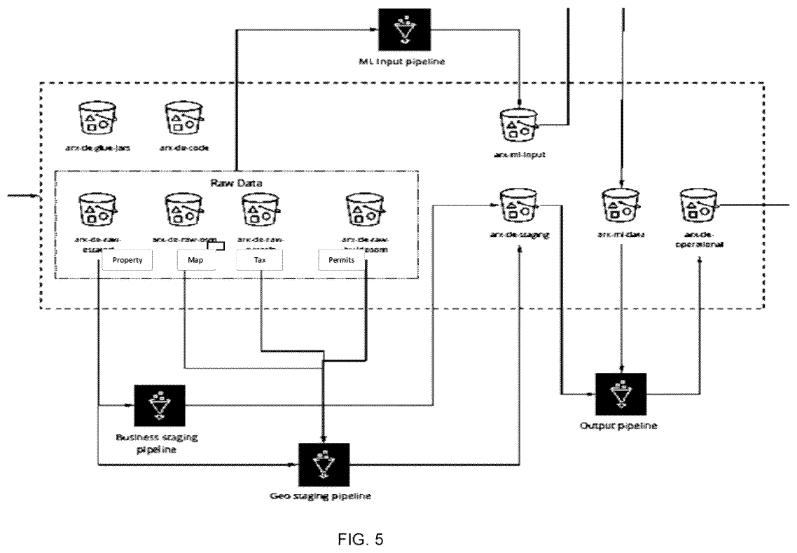

FIG. 5 shows the system architecture for The Machine Learning (ML) Input pipeline. It comprises three separate jobs that produce three outputs: a Market Pricing Model Input, a UOWCBB Input and a Time Module Input. Data generated by these jobs are used in Machine Learning models to improve data processing and analysis.

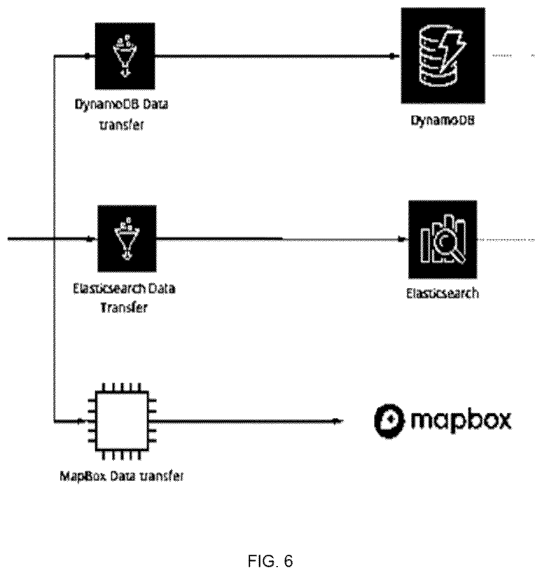

As shown in FIG. 6, the data output pipeline produces 3 outputs: The Map tool Output, Megatable Output, and the Search tool output to an output data bucket.

This pipeline mixes together data created from previous pipelines with output from the Machine Learning models to provide final outputs for the UOWCBB Module, the Market Pricing Model and the Time Module. Combined data are then put through to and pre-calculations are done in the Cost Module and the Financial Module.

There may be some cleaning and transformation of data here, in addition to enrichment. Enrichment comprises defining missing variables based on machine learning predictions that may be necessary for the Cost Module to function. Variables may include stories count, first floor area, calculated gross area, building perimeter, etc.

The cost module is a package used to calculate construction hard and soft costs. This package is used by the backend and data engineering. It includes a regressions calculator to precompute and store quadratic regressions of construction costs with given parameters given project footage and area based on data from an external provider. The dependent variable of the regression is the cost per square foot of the construction system component and the independent variable is the living area of the new construction. In embodiments, third degree Polynomials of the living area and Linear Regression model may be used to train the models. In an implementation we trained 1080 models for all possible combinations of building quality, stories count, wall types and system components. It also includes an assumptions function responsible for filling in missing construction parameters with default values and adjusting the cost using data from an external provider based on time and location of the project. The cost calculator combines information from the Regressions Calculator and Assumptions function and additionally calculates the costs of any additives in the project based on data from an external provider to calculate overall construction hard and soft costs.

After cost module calculations, cost module data are written to temporary storage (s3 buckets), to speed up the process of the next module, the financial module. Running the entire pipeline without any checkpoint could cause failures and loss of performance due to complex transformations (data cleaning, different kind of transformations, types casting, multiple joins between partitioned and not partitioned data, cost module UDF, etc.). With this approach, most of the transformed data are stored on s3 bucket and the financial module (which is the most demanding calculation), will run the latest intermediate data (written in temporary storage). In case of crash/job failures it does not have to retry specific partitions and run entire calculations once again, it just has to read data once again from s3 storage and put specific partitions through the financial module.

The financial module considers outputs such as total project cost from the cost module for an unmodified property and each reconfiguration together with financial cost values to determine a financial output. In embodiments, the module may calculate financial outputs according to two algorithms: Loan to Cost or Loan to Value. In the Loan to Cost method, a loan amount is defined as loan to cost multiplied by total project cost. The algorithm is an arithmetic sequence sum starting at the equity requirement subtracted from the acquisition price and end at the loan amount, multiplied by monthly interest rate (annual interest rate divided by twelve). General and administrative costs, origination fee translated to dollars, and closing costs also in dollars are added as are all remaining costs. The Loan to Value method, is similar, but the loan amount is defined as loan to cost multiplied by gross sales revenue. Mathematical approximations are used to avoid doing iterative calculations, reducing computational usage and demand.

Financial models are used to precompute two scenarios for every potential configuration (with debt financing and without). Summary and all the necessary inputs of those computations are stored in the database, then those models are used by the backend to calculate the cash flow every time a user selects the configuration to save space in the database. The backend also recalculates summary and cash flow every time user adjusts the inputs of a model.

The Financial module also predicts future income based on one or more strategies, for example depending on whether the property is to be sold or held after reconfiguration. Strategies include for example, Build to sell, Build to rent, or Rental. The model comprises two functions, Cash Flow and Summary. These functions calculate data according to the given input and return calculated values. All the inputs may be precalculated and stored in the Megatable database or manipulated from the frontend side of the application. The module can also calculate financial outcomes using manually populated inputs.

Also as seen in FIG. 6, the Upload pipeline takes the outputs from the previous modules and stores them in databases. It comprises 3 separate jobs: a Megatable upload, a Search tool upload and a Map tool upload. The fully processed data is stored in a Megatable table, and may be queried using the Search tool.

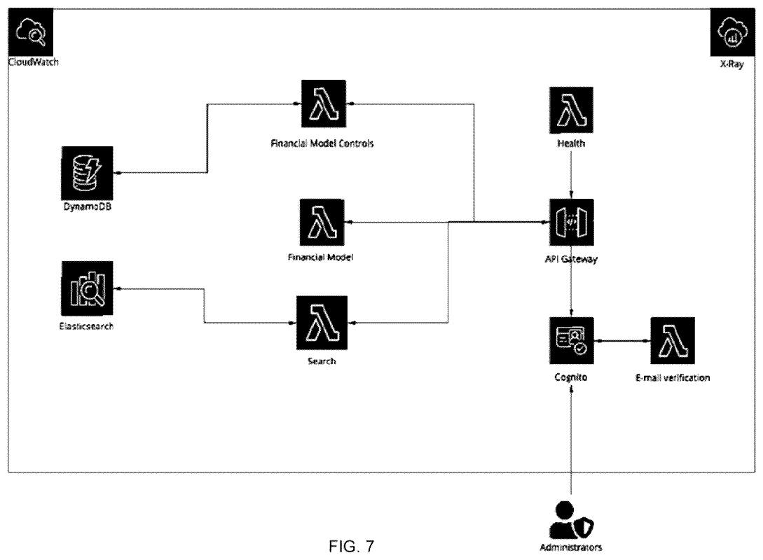

An architecture for administrators to interact with the backend system is shown in FIG. 7. Api gateway is an AWS service which creates API with an HTTP endpoints and enables routing to lambda functions through the HTTP protocol. AWS X-Ray is used to analyze and debug applications on a production environment. It allows identification and troubleshooting the root cause of performance issues and errors. AWS Cognito is used as an authorization service, which allows users to sign-up and sign-in to the application. The Financial Model Controls retrieve preconfigured data about the financial model of the project according to the request parameter OID. Data are retrieved from the Megatable Table. The Financial Model is used for running calculations of the financial model based on a given input data. The Search function is used by the frontend to search for OIDs and CIDs in the Search tool and filter the results by given criteria. E-mail verification is used to verify an authorized user. The Health function checks if the backend is up and running. CloudWatch stores logs from the lambda functions.

### Frontend Process Flow (Diagram)

Returning to FIG. 1E, the Frontend of the system has two primary functions. It allows users to filter and search for real estate properties based on both existing property characteristics and simulated project characteristics. Users can “load” a pre-simulated run of the FMM. It also allows users to change inputs to the FMM and immediately see how those changes impact the outputs of the FMM.

Users have the ability to interact with a front-end interface to the FMM. Queries are sent live to the FMM, where results are computed and sent back to the front-end display.

In embodiments, the system may provide the ability for a user to update both the existing conditions and proposed configuration(s) for a property, which would then override the existing property characteristics/UOWCBBM outputs, necessitating a re-run of steps 2-8 above.

In embodiments, the system may catalog user inputs into the front-end interface. These user inputs will, over time, form a unique set of data that can be used to enrich existing models. For example, user inputs can be used in machine learning applications layered on the Megatable to improve the efficacy of predictions from the various modules described herein by correlating use query data with potential configurations determined by the UOWCBBM.

The system provides users with automated real estate consulting services in a substantially more cost-effective and user-specific manner than alternatives.

Previously, real estate consultants and other technology platforms analyze properties for their users on a site-by-site basis. The user indicates that they are interested in a site before the consultant or platform simulates a few different potential projects on that site. The user has no way of knowing if the potential projects are of interest (and therefore, if the site is of interest) before the simulations are run. When potential projects are found to be unappealing for whatever reason (metrics that can only be determined by simulating the project), the user's time and money is wasted.

Notably, the system disclosed herein allows a user to select properties on a results-organized basis and not a single-property-centric model as conventionally done. A user does not need to have a specific property identified before performing a financial analysis. Further, the system can analyze a plurality of properties that may or may not be currently offered for sale, allowing a user to search for potential properties to be acquired and reconfigured based on the user's preferences.

The system disclosed herein pre-simulates many (with the goal of simulating “all”) projects and allows the user to search for properties based on the metrics that can only be determined by simulating the project.

The architecture of the system is such that the underlying datasets can be augmented and improved. Similarly, the algorithms used to process the datasets can be augmented and improved through self-training and human-made improvements.

The system described herein provides a platform for scoring and comparing the potential of development for individual properties to allow a user to find properties with the highest profit potential based on their criteria without having to select a property to assess. Previous platforms try to approximate the potential of a property's future profitability by creating developmental potential scores. Such scores are typically created by taking the difference between the height of an existing building and the building height allowed by zoning code, taking the difference between the volume of an existing building and the volume allowed by zoning code, or taking the difference between the area of an existing building and the maximum buildable area allowed by zoning code. The system described herein uses a much more holistic approach, considering multiple parameters and comparing multiple properties.

Once a user is logged in, the application stores user authorization token that is used to query data. A User can interact with application and financial model by typing a property address, selecting elements and/or changing values.

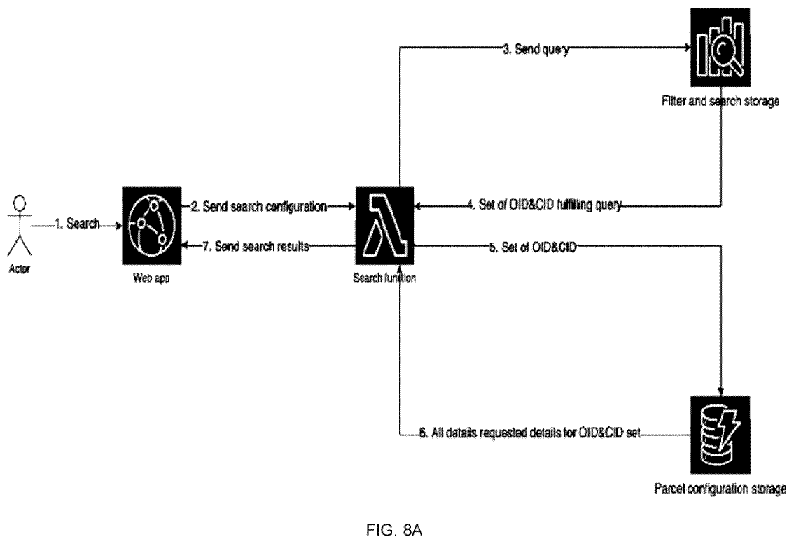

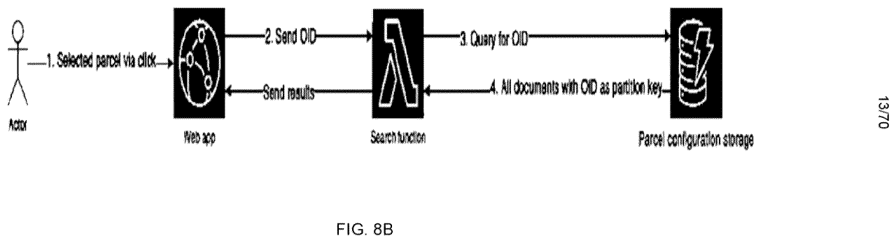

FIGS. 8A and 8B show schematic diagrams of a user interacting with the system using the front end.

Datasets need to be connected based on ID in order to fulfil different queries coming from a front end application. A universally unique identifier (UUID) is a 128-bit number used to identify information in the computer system CID is a UUID of a property reconfiguration. OID is a UUID of original property configuration in the Megatable, which is key-value (K-V) database or key-value store. A K-V database is a data storage paradigm designed for storing. retrieving, and managing associative arrays, and a data structure more commonly known today as a dictionary or hash table. The Megatable holds a pair of OID and CID, along with every property detail. This storage is treated as a key-value type storage, wherein each pair of OID and CID points to a property configuration. In Key-value terms, OID is partition key, while CID is sort key. This allows the system to reflect the fact that one property marked with OID can have many different variants, each marked with CID. In embodiments a first unique identifier (UID) may be associated with a property in its existing or current configuration, and at least one second unique identifier (UID) may be associated with the same property in proposed reconfiguration(s).

Data will connect based on pair of IDs (OID and CID). Current property configuration is the root document and its possible reconfiguration(s) will be variations using the same root ID.

In FIG. 8A, a user interacts with the data using a Search tool, which holds a pair of OID and CID, along with all properties required to support front end set of filters. Filter queries supported in the Search tool include filtering property configurations based on location and filter property configurations based on configuration properties. The frontend can fetch one configuration, using a unique pair of OID and CID, or fetch all configurations for particular property, use only OID.

Each filtering query will return a list of documents, each document in result is identified with pairs of OID and CID. The pairs can be used later to fetch all details for each property configuration from the Megatable.

As shown in FIG. 8B, for selection via a location or map, a Map tool is used. The Map tool holds only OID of a property. There is no need to provide CID's as they all have the same coordinates. All possible reconfigurations can be represented by the same point on a map. Once a user types at least 3 characters, a request to the Map tool is made. In response, the Map tool returns a list of suggestions. Alternatively, selection of a location on a map view can define a set of map coordinates that can be linked to an OID. Once the user selects a location, coordinates of the location are retrieved and passed to the Map tool. The Map tool navigates to a specific location and the system retrieves property data. The closest property to the given coordinates is found, its OID is stored in application store. The user may request certain parameters or the system may retrieve all available scenarios for the user to review. If specific parameters are requested, calculation on the backend side can be made based on those variables.

When the User interacts with the data, the Frontend application implements a so-called store-a state container. That allows the system to monitor each value change in a specific store. This is important, as the user can interact with inputs and adjust values. Each adjustment is reflected in the store and if a change is detected, API call is made with updated parameters. Updated response values are populated in the currently open UI elements.

The User will be allowed to search project based on multiple advanced search criteria. Selection of filters will be kept in user browser memory and will persist when navigating through application. Filters that can be applied include: strategy, schedule, and financial. Filters can comprise dropdown selects, range sliders or text inputs to be able to perform advanced search by filtering the project's strategy, schedule and financials. User will have option to quickly navigate to most important filters from a quick filters bar. When specific filters will be selected, an action to apply is required. Filters will be passed as parameters in order to return matching results. In the same time map view should be updated via communicating with the Map tool. If the user applies filters after list of projects is returned, the list will be updated automatically.

After a user applies location search and filters (not required) a list of projects for the location is displayed. A user sees different configurations on the same property as separate results on the paginated list.

From that view, the user can save any project to favorites. In quick preview, on the card, user sees base project information, its criteria. By default, projects are sorted from the most beneficial ones, but custom sorts can be applied.

When the user is interested in a specific project, the project can be selected. At the same time, request is made for detailed information of the project. When a user hovers on the project list, the correspondent point on the map is highlighted.

Project summary is a view available after selecting a specific project from the project list view. On this view, user can read about various detail of the project, from asset type, through acquisition price, financing on IRR. User also can read about existing physical property details such as: living area, floor numbers, height, parking type etc.

From this view, the user can add project to favorites (same action as when result list is used) or go to a detailed project financial model.

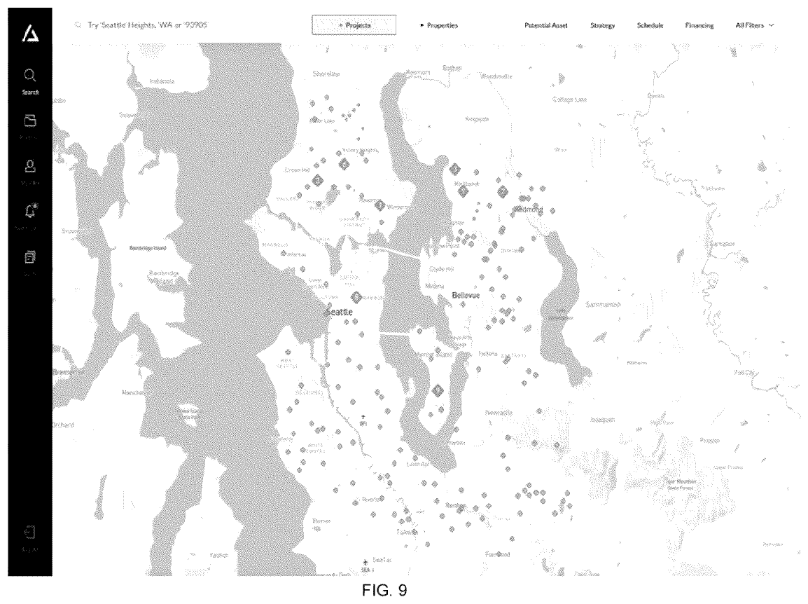

FIGS. 9 through 66 show screenshots of a front-end implementation of the system, according to exemplary embodiments of the disclosed subject matter. These are design wireframes that serve to illustrate a front-end interface that is being developed. These figures illustrate how a user can interact with the front-end, but they are not limiting. Other screens with different appearance may be used with similar functionality to those shown herein. The platform in its current state allows a user to input an address and then be loaded directly into the prepopulated financial model, or, input a geography such as a city or a zip code, in addition to other input parameters, and be presented with a list of pre-simulated potential projects

FIG. 9 shows a Map (initial view). The initial view is what a user sees upon logging into the computer system platform. When the “Projects” button is selected, the map displays and the user is querying the Megatable for properties based on potential project pre-simulations. When the “Properties” button is selected, the map displays, and the user is querying the Megatable for properties based on existing property characteristics.

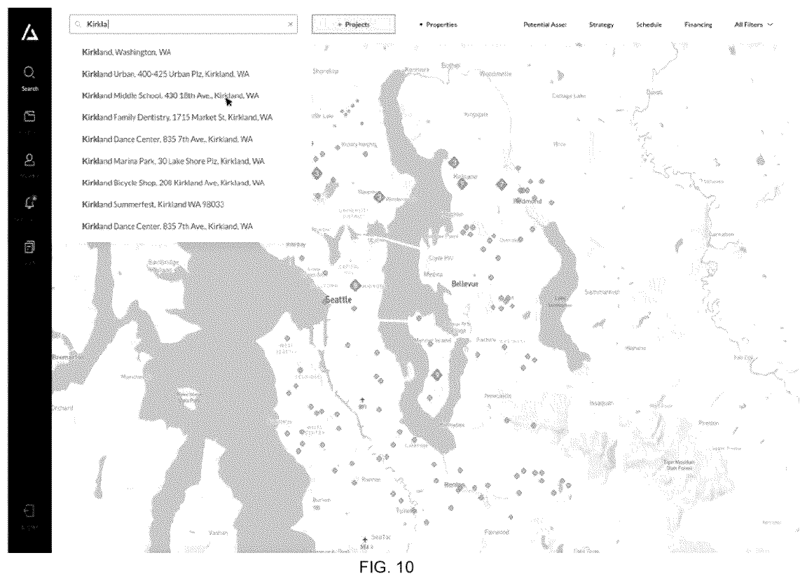

FIG. 10 shows a Map (location search) view. A user inputs a geographic unit of analysis that they would like to search by. In the example, the user is selecting the municipality of Kirkland, WA as their search location. This user input is communicated to the backend system, which then displays the results from the Megatable that correspond to the user input.

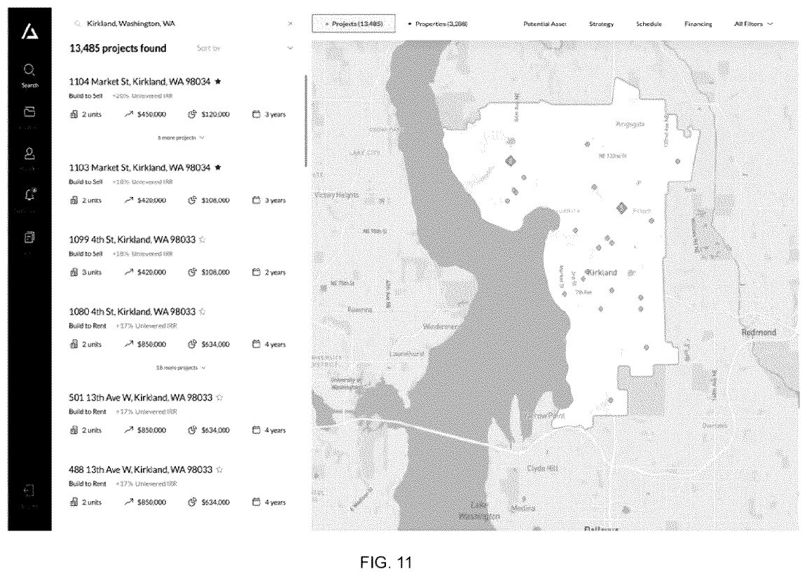

FIG. 11 shows a Search Results—Projects view. The platform displays the most profitable projects in the selected geographic unit of analysis, as sorted by unlevered IRR, in the results column on the left side of the page in descending order. The projects are displayed as Project Cards, which display project attributes such as Unlevered IRR, Asset Type, Unlevered Profit, Project Cost, Project Length. These attributes are the direct outputs of the system's simulations. As multiple potential projects can exist on one property, the option to see additional projects can appear below a Project Card.

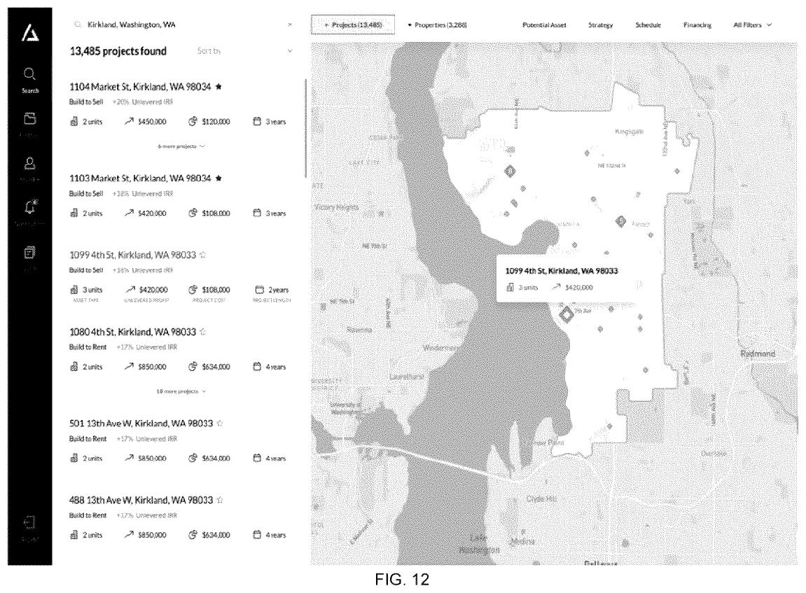

FIG. 12 shows a Search Results—Projects (hovered view). A user can hover over a specific Project Card in the left column in order to see the corresponding property highlighted on the map.

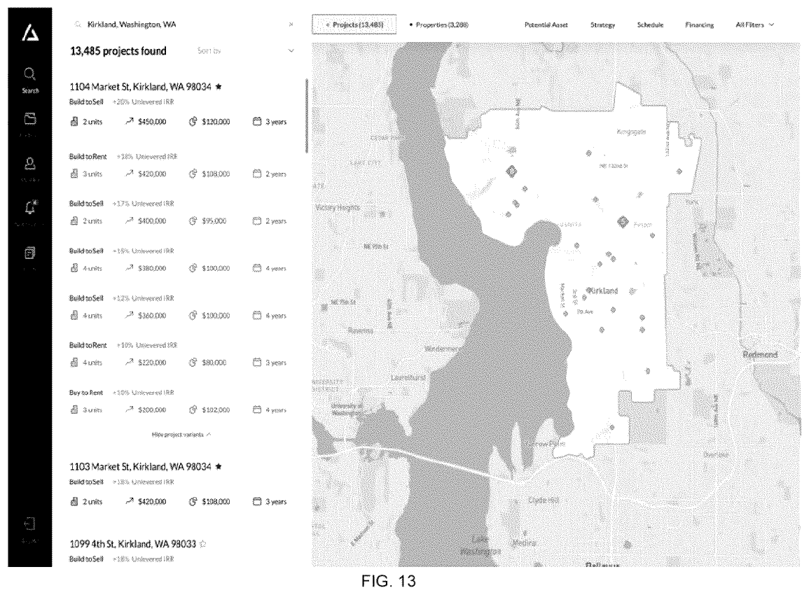

FIG. 13 shows a Search Results—Projects (expanded view). A user can click on the dropdown indicating additional projects under a Project Card. The expanded list displays other possible future projects that the system has simulated on the property. A user can quickly compare different future scenarios, across potential asset types, strategies, and schedules.

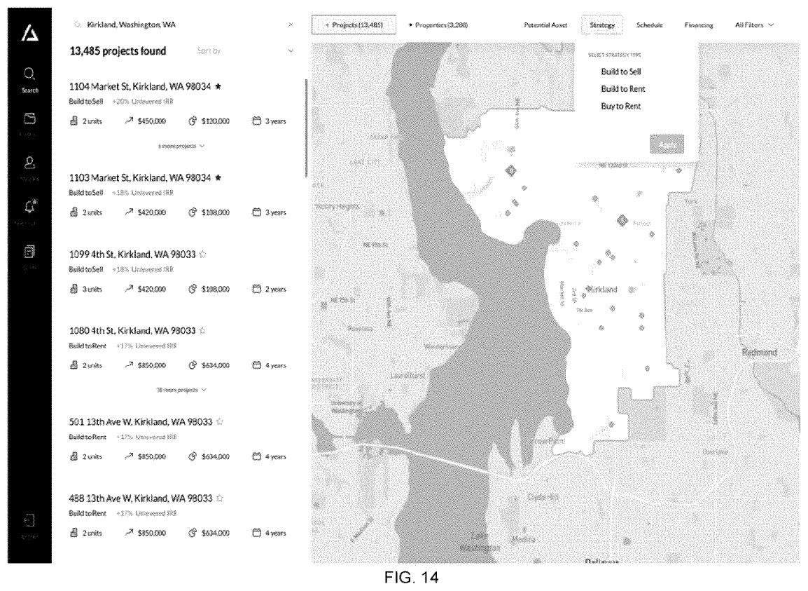

FIG. 14 shows a Search Results—Quick Filters (open)—Strategy view. With the Projects toggle active, users can adjust Project quick filters in the top right of the screen, such as Potential Asset, Strategy, Schedule, and Financing. These attributes are the direct outputs of the system's simulations.

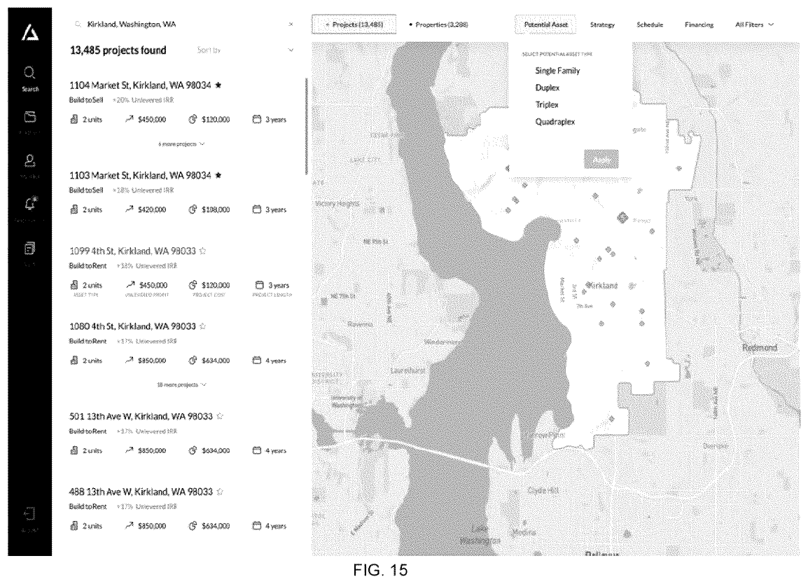

FIG. 15 shows a Search Results—Quick Filters (open)—Asset Type view. With the Projects toggle active, users can adjust Project quick filters in the top right of the screen. In this view the Asset Type drop-down menu is shown.

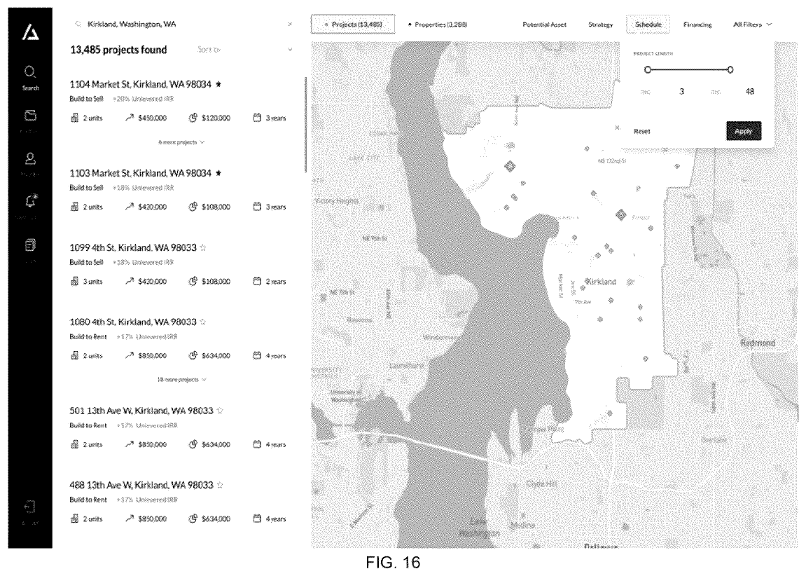

FIG. 16 shows a Search Results—Quick Filters (open)—Schedule view. With the Projects toggle active, users can adjust Project quick filters in the top right of the screen. In this view the Schedule drop-down menu is shown.

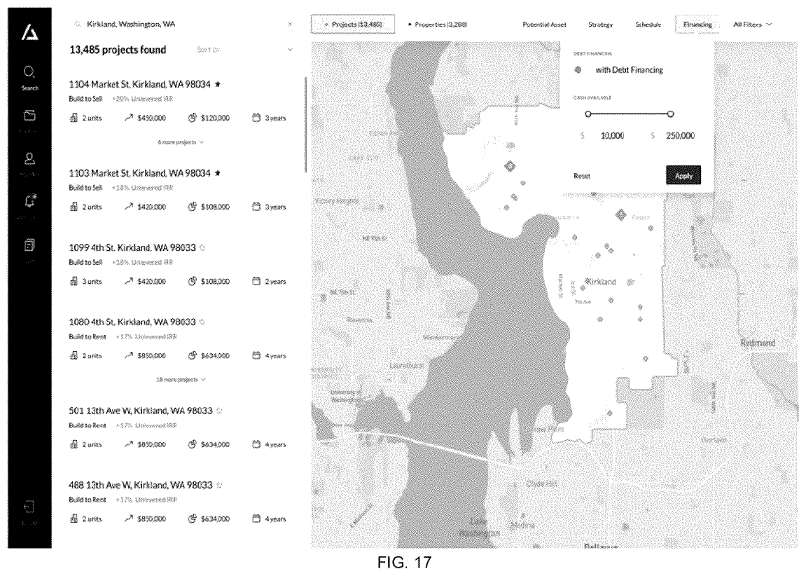

FIG. 17 shows a Search Results—Quick Filters (open)—Financing view. With the Projects toggle active, users can adjust Project quick filters in the top right of the screen. In this view the Financing drop-down menu is shown.

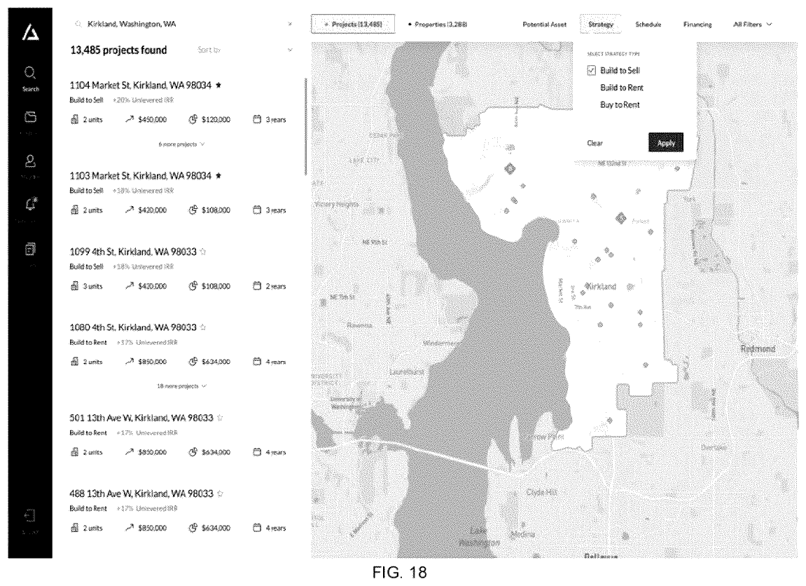

FIG. 18 shows a Search Results—Quick Filters (selected) view. With the Projects toggle active, users can adjust Project quick filters in the top right of the screen. In this view the Strategy drop-down menu is shown.

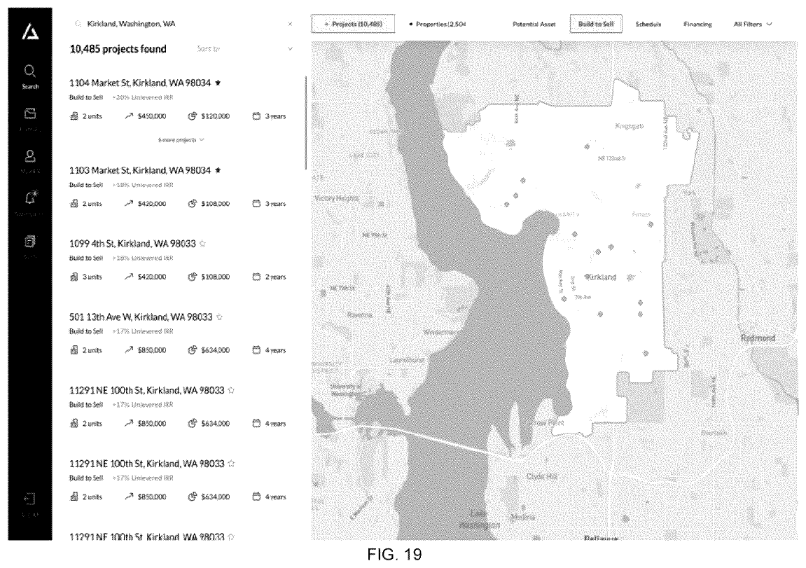

FIG. 19 shows a Search Results—Quick Filters (selected) view. Applying one of the quick filters updates the list of projects displayed to the user. Here, a user has selected to refine the results to only include Strategy: Build to Sell. In response, Buy to Rent and Build to Rent projects have been excluded from the results column.

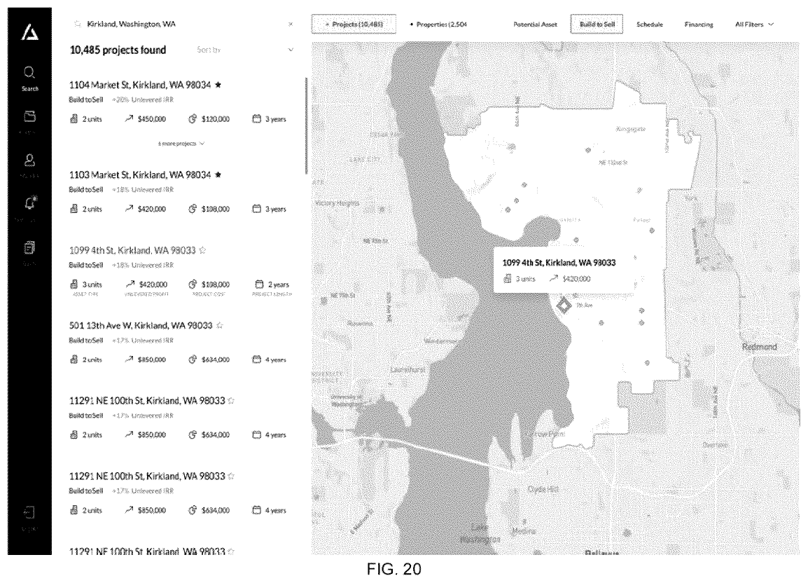

FIG. 20 shows a Search Results—Quick Filters (selected & hovered) view. A user can hover over a specific Project Card in the left column in order to see the corresponding property highlighted on the map.

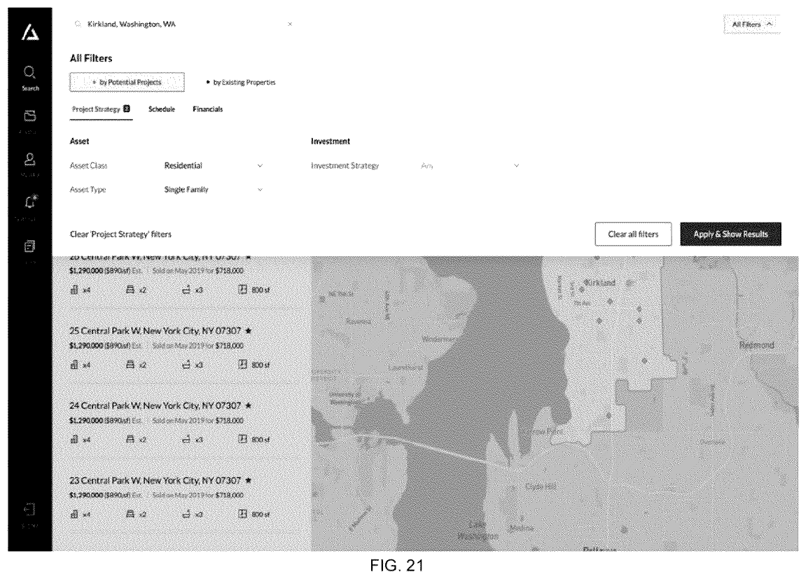

FIG. 21 shows a Search Results—More Filters view. In addition to the quick filters, a user can click the “All Filters” button to bring up a menu with additional project and property characteristics to filter results by. A user can search by both Project and Property attributes, simultaneously. For example, a user may want to search for projects with the attributes Strategy: Build to Sell, Schedule: 10-24 Months, on properties that have certain Existing Property Attributes such as Lot Width: 25 Feet and Lot Depth: 100 Feet.

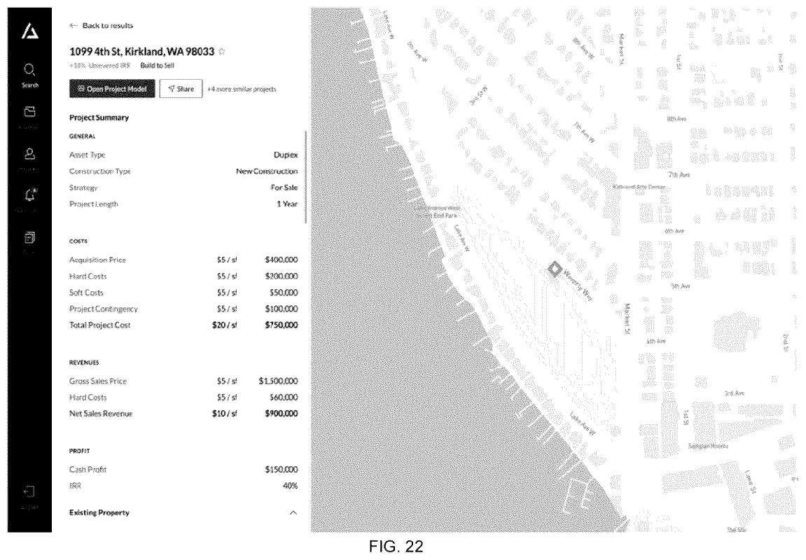

FIG. 22 shows a Project Details view. A user can select a Project Card in order to enter the Project Detail view. The Project Detail view contains a Project Summary, allowing a user to see at a glance the high-level inputs into the FMM. Break-out of project specifics such as Asset Type, Strategy, Project Length, Costs, Incomes, and Return Metrics are displayed at a glance. The “Open Project Model” button present at the top left of the screen allows a user to enter a front-end interface for the FMM and make adjustments to Project assumptions. Users can click the “Existing Property” tab at the bottom of the screen to bring up existing property attributes.

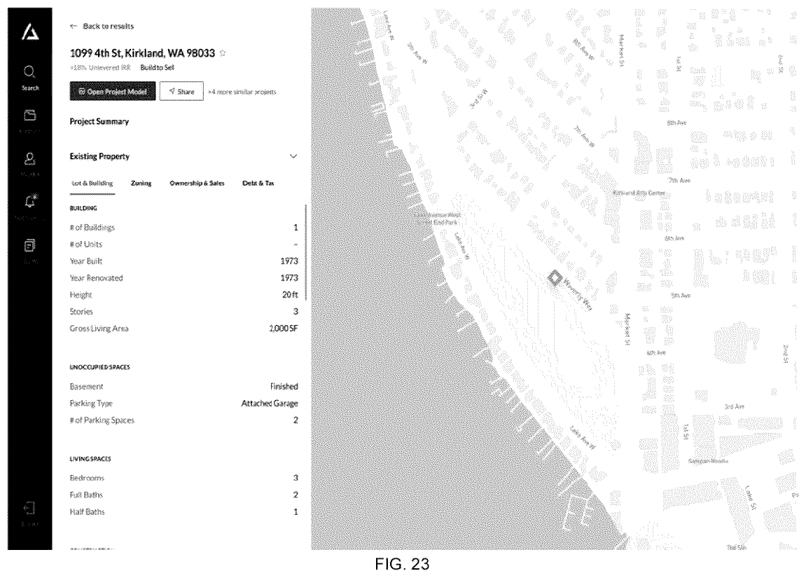

FIG. 23 shows a Project Details (existing property) view. The “Lot & Building” tab provides users with information on existing property attributes related to the lot, and the building on the lot.

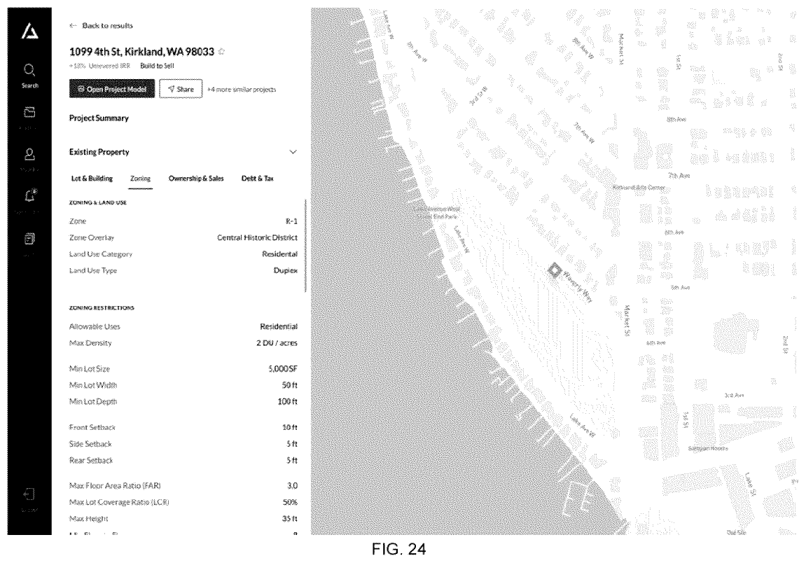

FIG. 24 shows a Project Details (existing property—zoning) view. The “Zoning” tab provides users with information on the property's zoning code attributes.

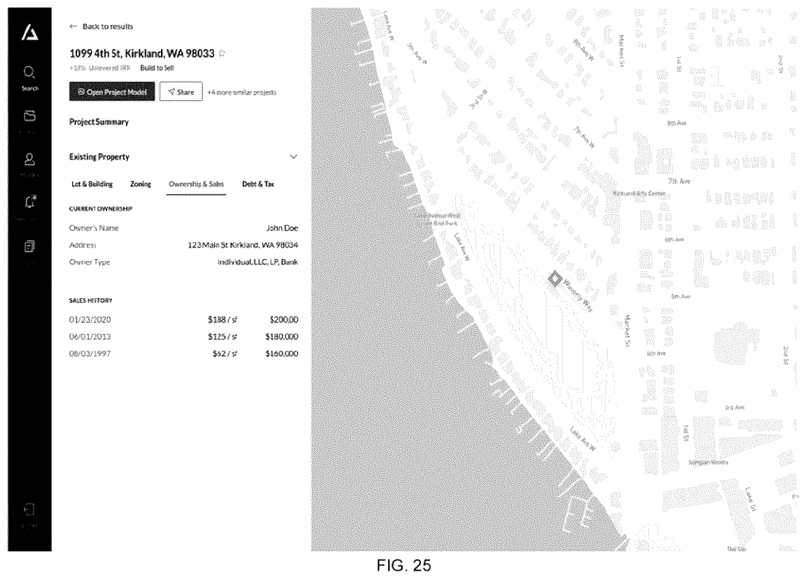

FIG. 25 shows a Project Details (existing property—O&S) view. The “Ownership & Sales” tab provides users with information on the current owner of the property, in addition to past sales history.

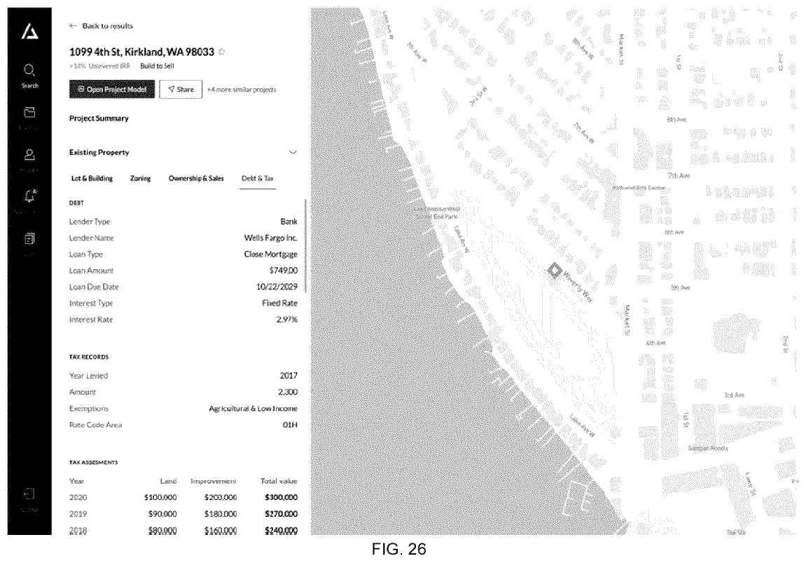

FIG. 26 shows a Project Details (existing property—D&T) view. The Debt & Tax tab provides users with information on the current debt profile of the property, as well as its tax records and prior tax assessments.

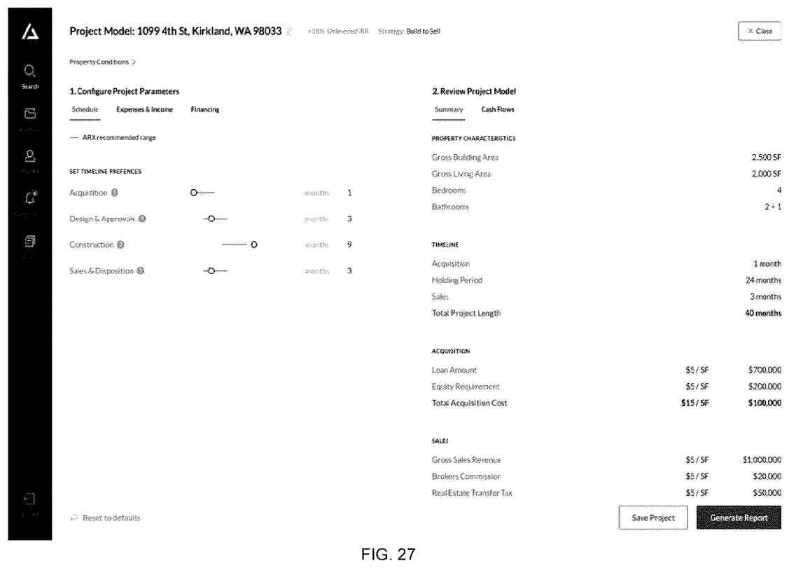

FIG. 27 shows a Project Financial Model (start) view. This is the Project Model screen that a user sees upon clicking “Open Project Model” on the prior screens. Clicking that button loads a user directly into one of the system's pre-simulated scenarios. This screen is a front-end user interface for the user to interact with the FMM. Here, the user can see the system's simulation (every assumption is prepopulated with the results of the Backend Process Flow), in addition to recommended ranges showing the user what the system predicts as the recommended range for each assumption. Users can deviate from the recommended range.

Inputs to the FMM are grouped on the left side of the screen, while outputs of the FMM are grouped on the right side of the screen. As a user makes adjustments to any input, the right side of the screen updates in real time.

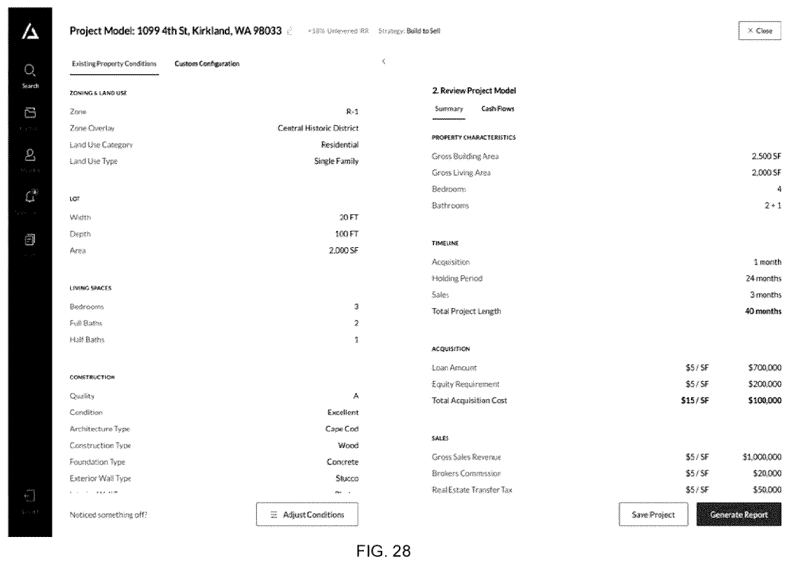

FIG. 28 shows a Project Financial Model (Property Conditions) view. Clicking the “Property Conditions” button in the top left of the prior screen brings the user to a screen showing existing property conditions. These are the existing property conditions or attributes per the system's database, and are inputs into the system's simulations.

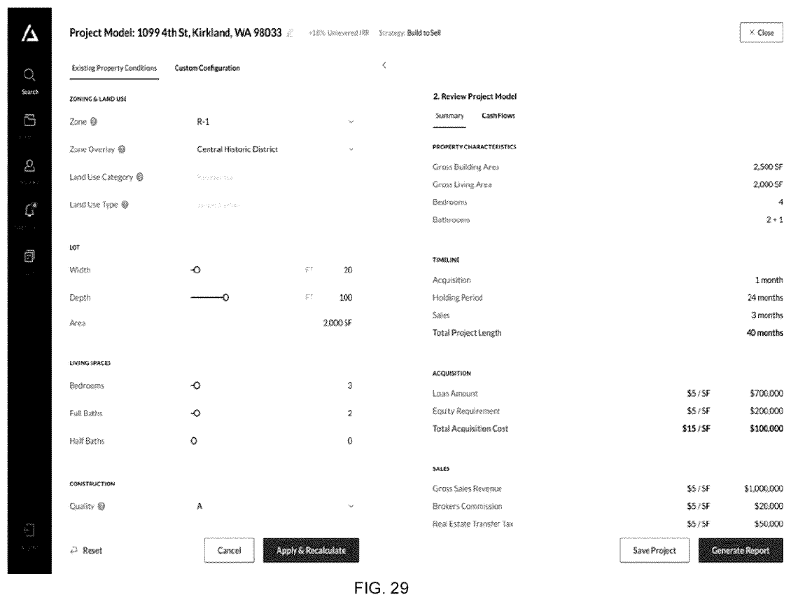

FIG. 29 shows a Project Financial Model (Property Conditions—editable) view. If a user thinks that one of the Existing Property Conditions is incorrect or if the user wants to see the project with adjusted conditions, they can click the “Adjust Conditions” button and make modifications. Modifications serve two purposes:

User modifications will be cataloged by the system and used to augment datasets.

User modifications will be used to re-run the system's entire Backend Process Flow, live, in order to provide the user with accurate project simulations based on the adjusted conditions.

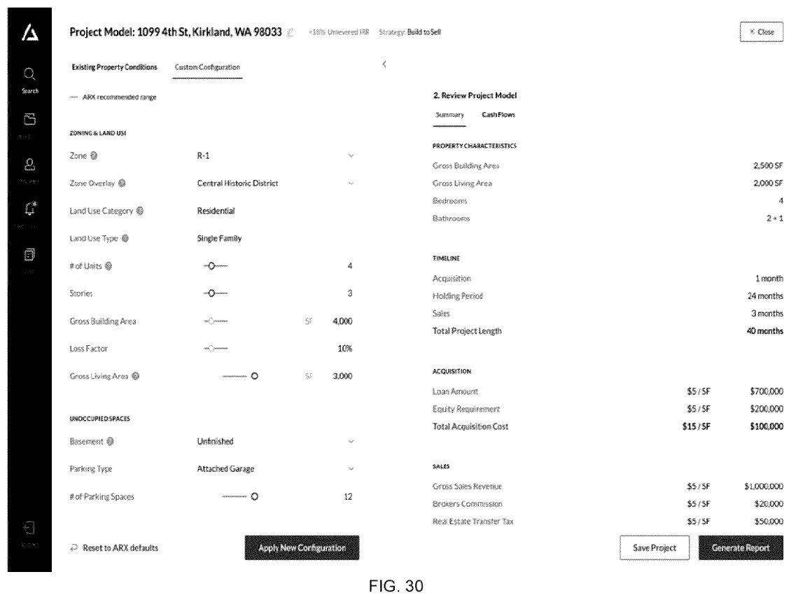

FIG. 30 shows a Project Financial Model (Property Conditions—Custom) view. Similar to prior screens, a user can view the Custom Configuration that the system's simulations are proposing. If a user wants to test a different configuration on the site, they are able to modify the configuration assumptions. Modifications serve two purposes:

User modifications will be cataloged by the system and used to augment datasets.

User modifications will be used to re-run the system's entire Backend Process Flow, live, in order to provide the user with accurate project simulations.

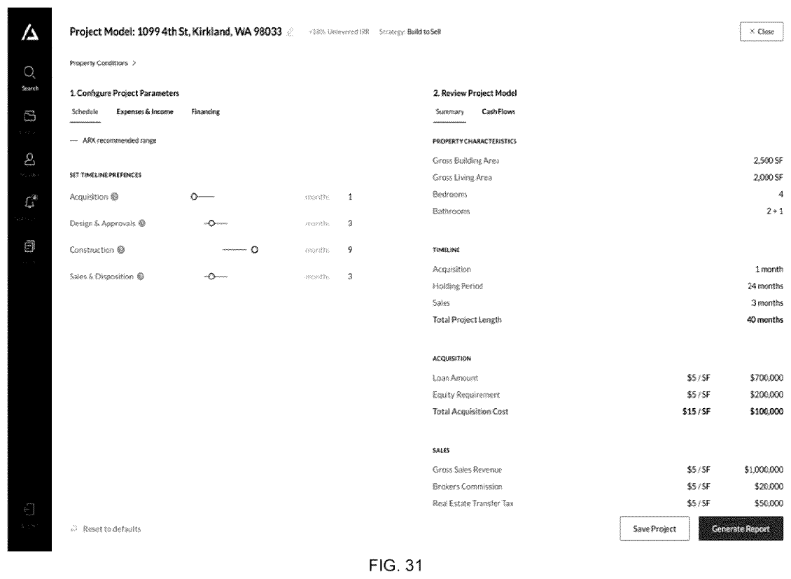

FIG. 31 shows a Project Financial Model (start) view. Users can view the outputs of the TM for a given simulation. Users can adjust timelines for different Project phases. The Project phases dictate when different components of the Project occur, which can impact project profitability. For example, the longer the Construction phase is, the higher the Financing Costs will be on the project. Similarly, all else equal, a longer project will result in a lower IRR.

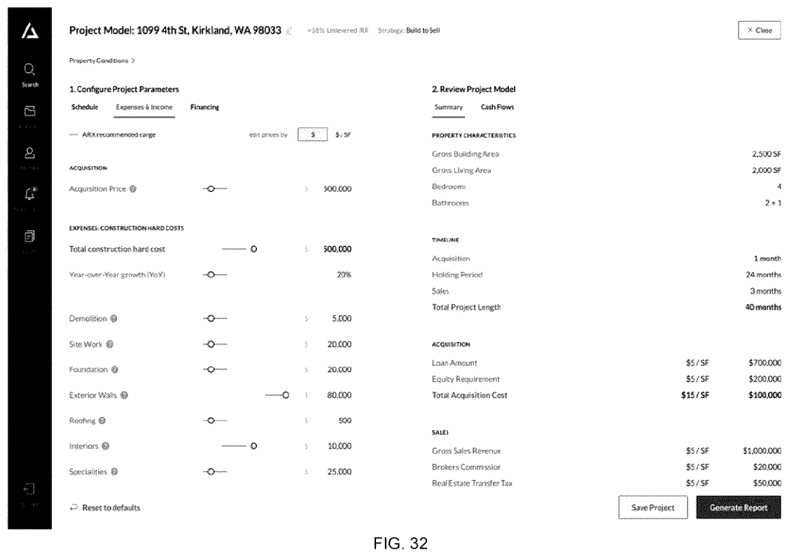

FIG. 32 shows a Project Financial Model (E&I) view. Users can adjust project expense and income assumptions via a variety of input methods. Users can click on the “?” icons next to each variable for an explanation of what is initially included in each category. Users can toggle between values displayed in absolute values or in $/square foot values. Adjustments can be made with either display option.

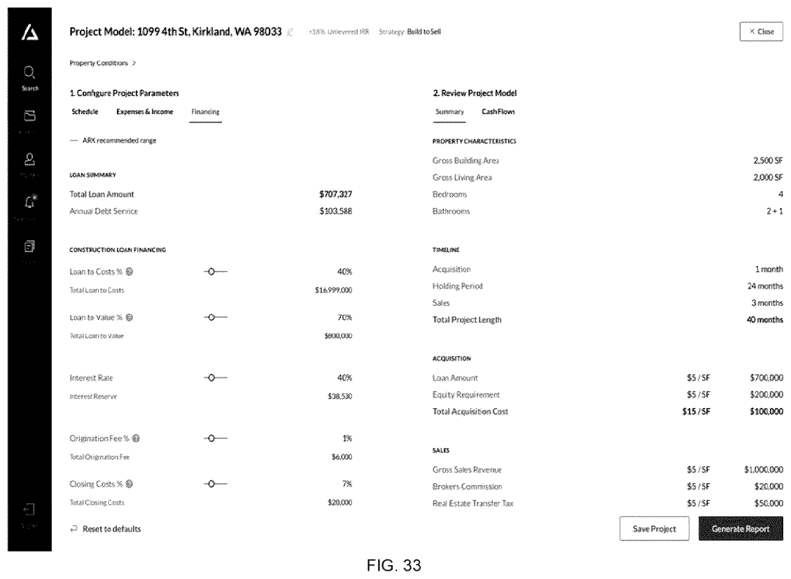

FIG. 33 shows a Project Financial Model (Financing) view. Users can adjust debt financing assumptions and view the impact on project capital structure and profitability. While debt calculations and interest reserve calculations are typically handled through multiple iterative calculations, the system approximates the calculations using mathematical expressions. These approximations allow the system to display the loan amount and interest reserve with a maximum error of 0.01%, and necessitate a single calculation instead of multiple iterative calculations.

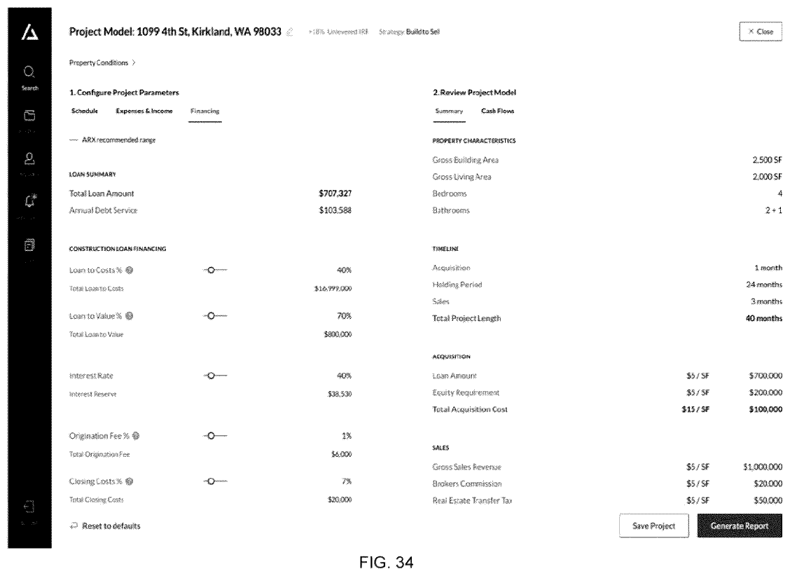

FIG. 34 shows a Project Financial Model (Summary) view. The summary tab on the right side of the screen displays outputs of the FMM, adjusting live based on inputs made to the left side of the screen. Users can see at a glance high-level project information, including property characteristics, schedule, expenses and income, financing, and return metrics.

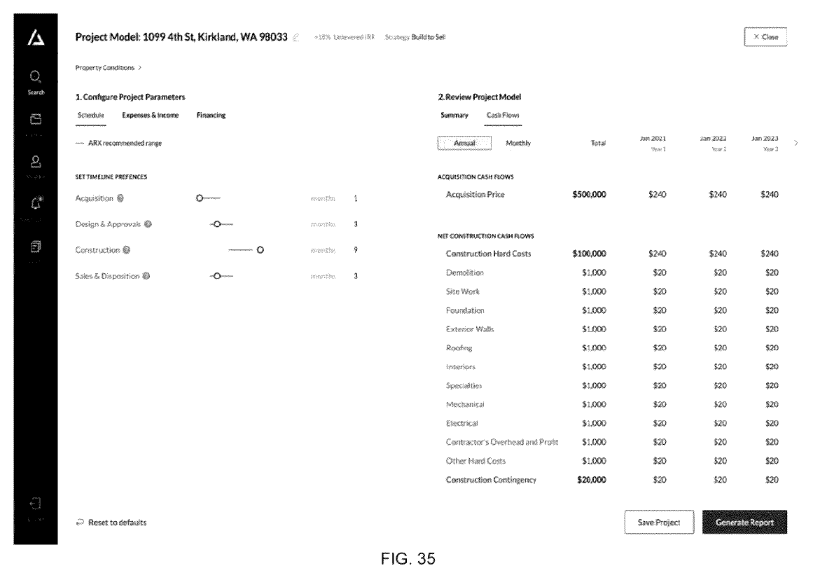

FIG. 35 shows a Project Financial Model (Cash Flows) view. The Cash Flows tab is a different view of the FMM outputs, displaying the project cash inflows and project cash outflows across time. The Cash Flows tab updates live based on inputs made to the left side of the screen, and is meant to mimic the detailed financial model that someone analyzing a real estate asset would build.

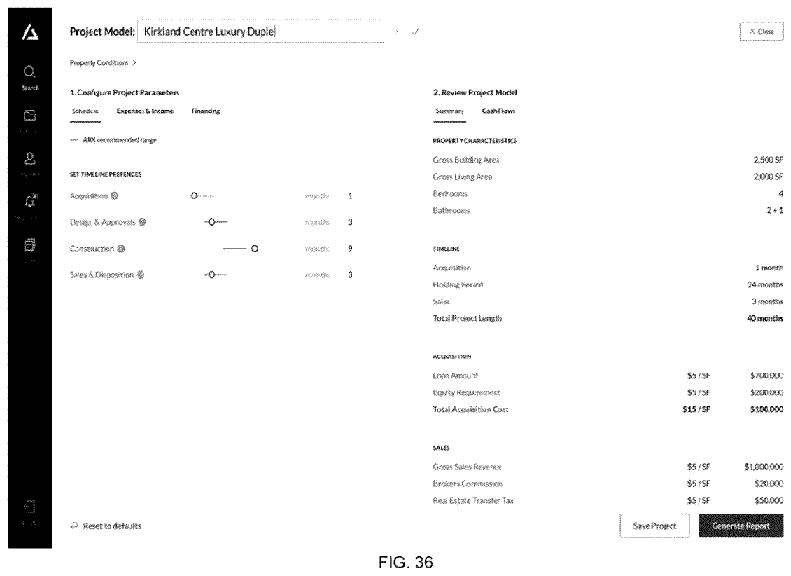

FIG. 36 shows a Project Model—rename (active) view. Users can name future projects, to better keep track of them in their portfolio.

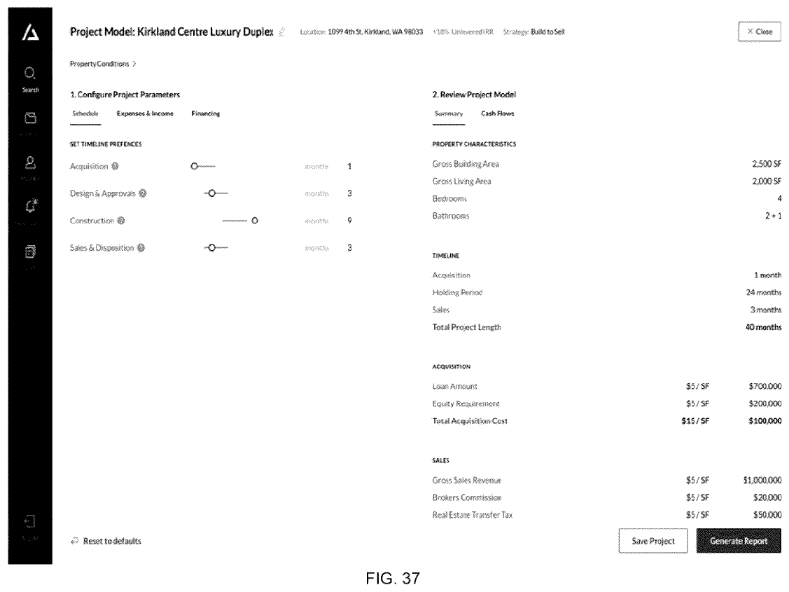

FIG. 37 shows a Project Model—rename (set) view. Users can name future projects, to better keep track of them in their portfolio. This view shows the renamed project in a Summary view.

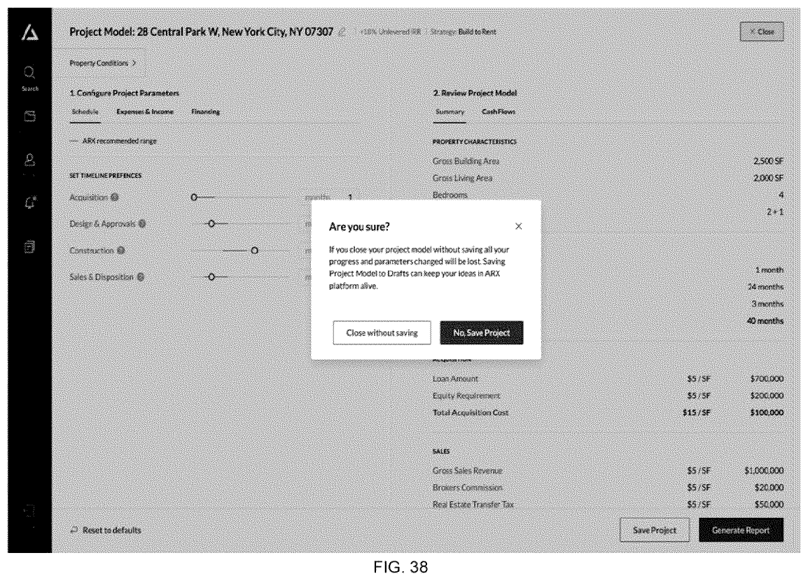

FIG. 38 shows a Project Model—close info view. Users can save and close a project with their adjustments made, available to be revisited from their portfolio.

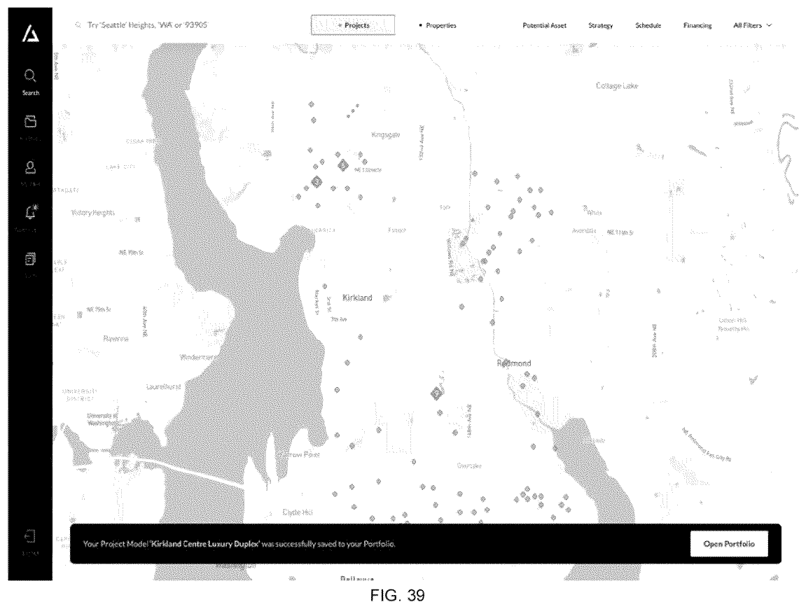

FIG. 39 shows a Map—project saved view. Users are informed about a project being saved and are prompted to view their other saved projects.

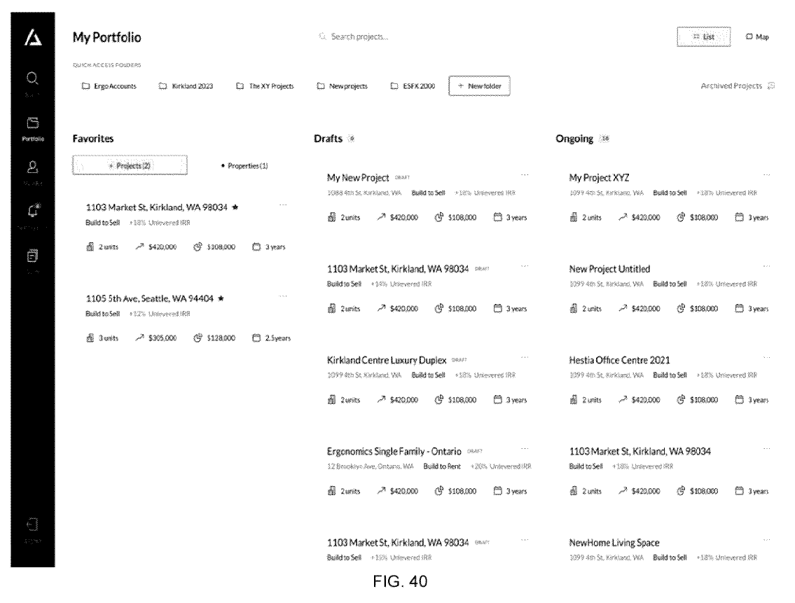

FIG. 40 shows a Portfolio view. The Portfolio serves as a repository for users to store and organize their activity on the platform. The leftmost column, “Favorites,” displays any projects and properties that a user has favorited while they have been querying Arx's database. The “Drafts” column in the center of the screen displays any projects that a user has saved, after interacting with the project. Users can load back into the financial model interface, with the assumptions in the same state as when they exited. The “Ongoing” column on the right side of the screen denotes projects that users have decided to move forward on. Users can additionally organize their projects according to custom quick access folders.

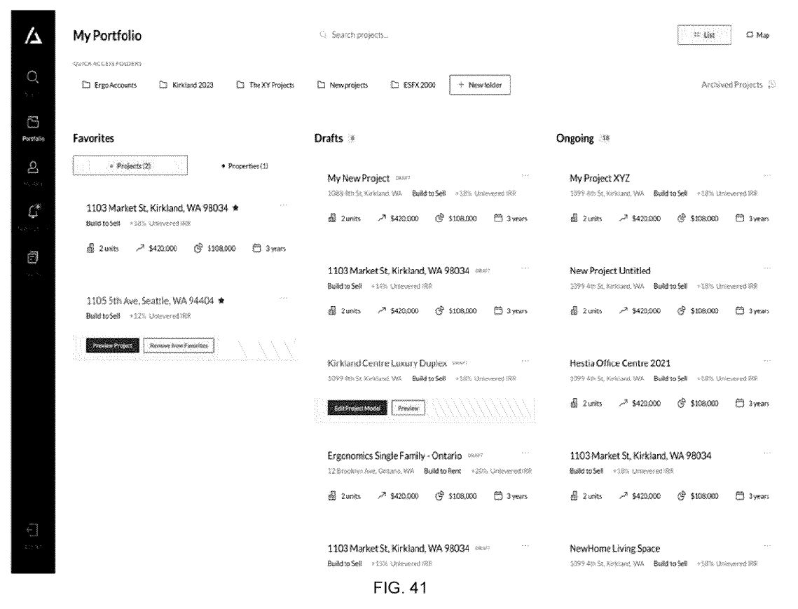

FIG. 41 shows a Portfolio (hovered) view. Users can hover over a project in order to be prompted to edit the project model, which brings them straight into the FMM interface, or preview the project model, which pulls up a subsequent overlay screen.

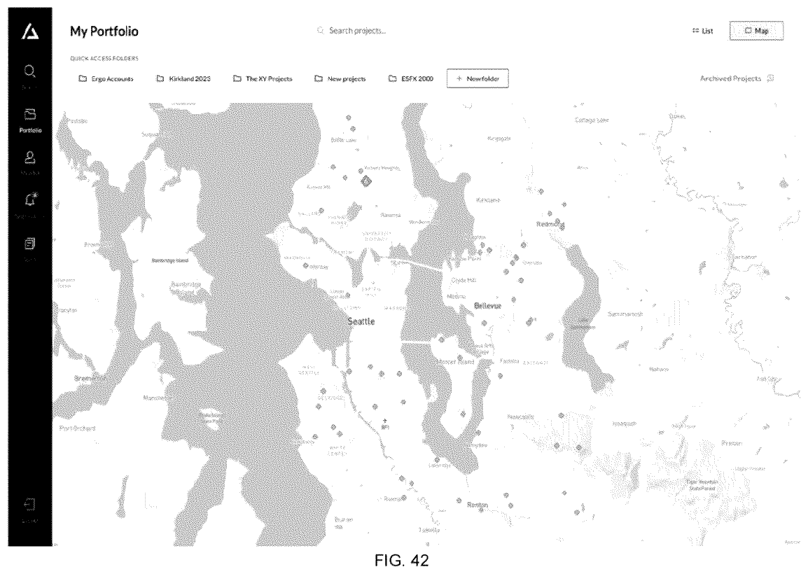

FIG. 42 shows a Portfolio (map view). Users can view their saved portfolio projects on the map.

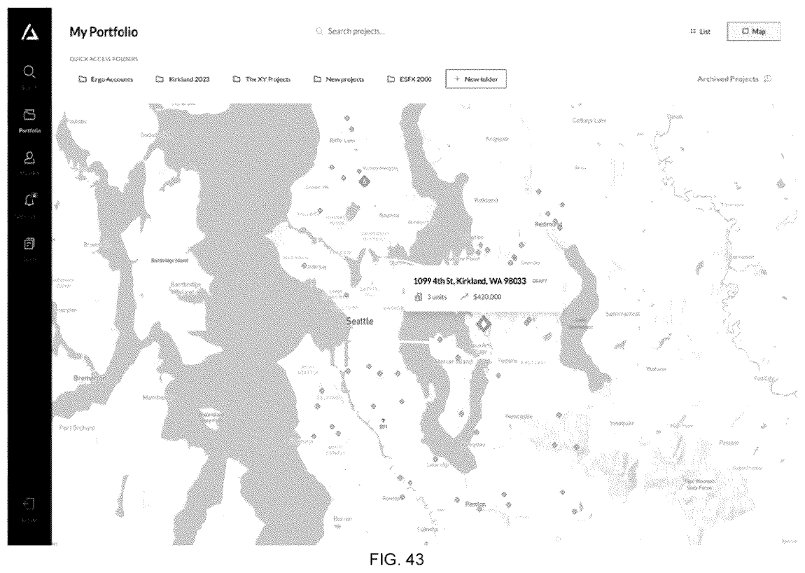

FIG. 43 shows a Portfolio (map view—hovered) view. Users can view their saved portfolio projects on the map.

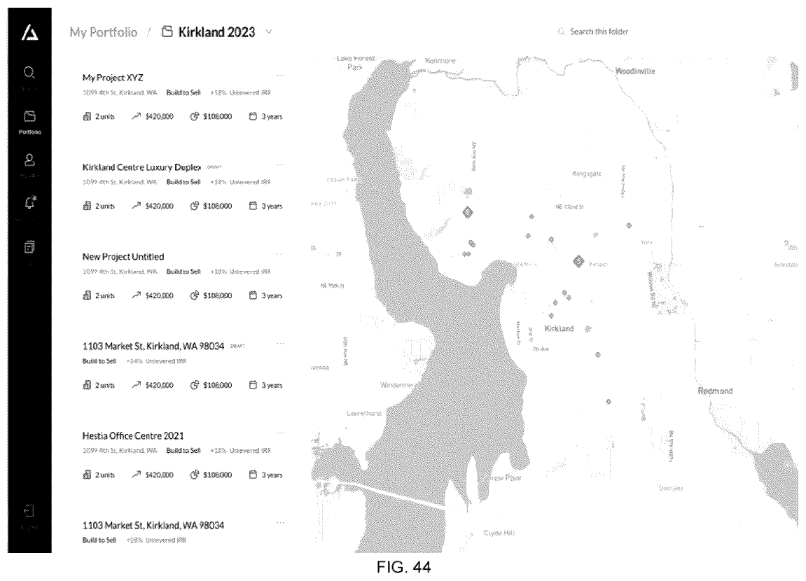

FIG. 44 shows a Portfolio—folder view. Users can organize their projects according to custom quick access folders.

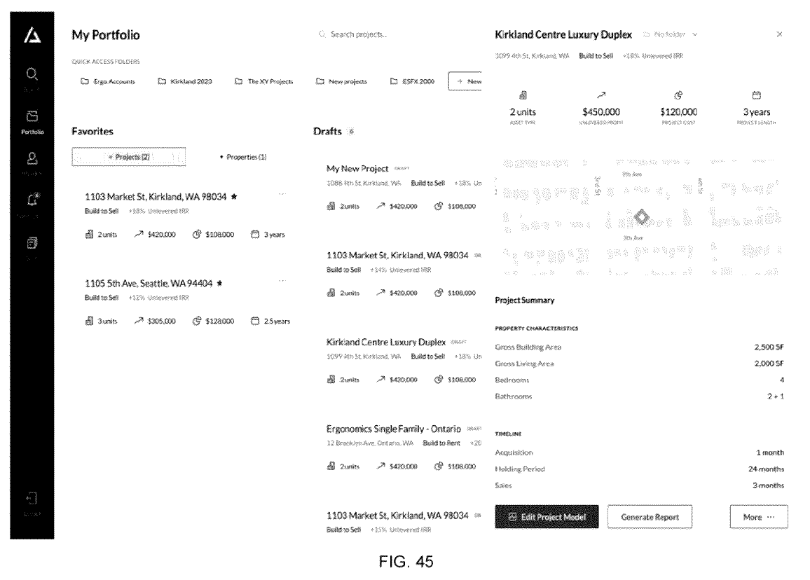

FIG. 45 shows a Portfolio—Project Details view. Users can preview the Project Summary directly from the portfolio.

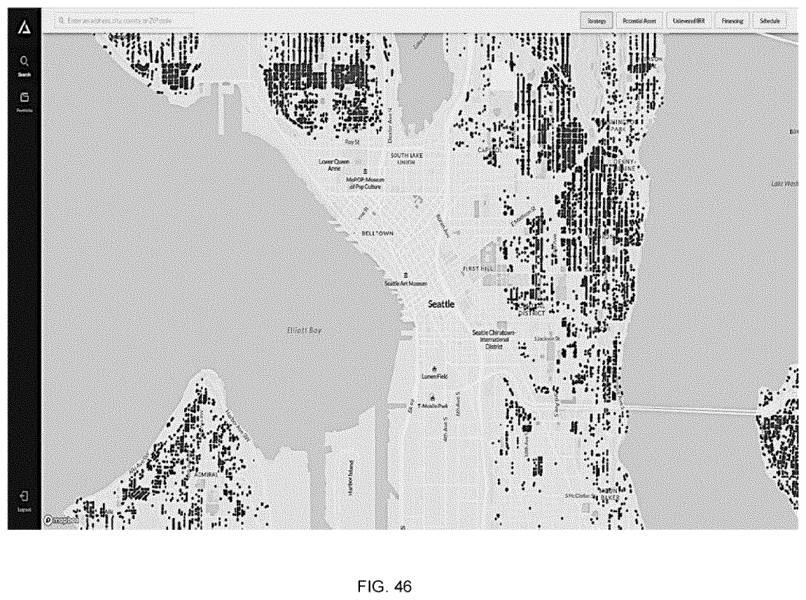

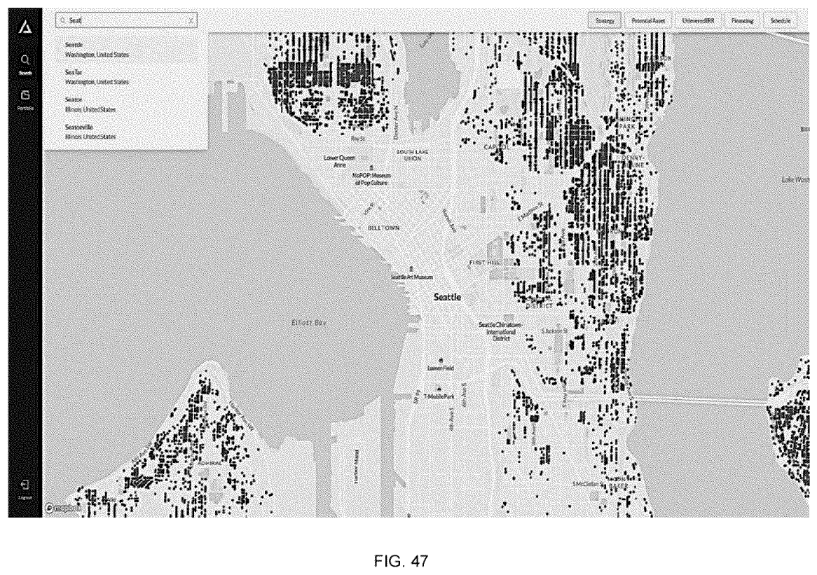

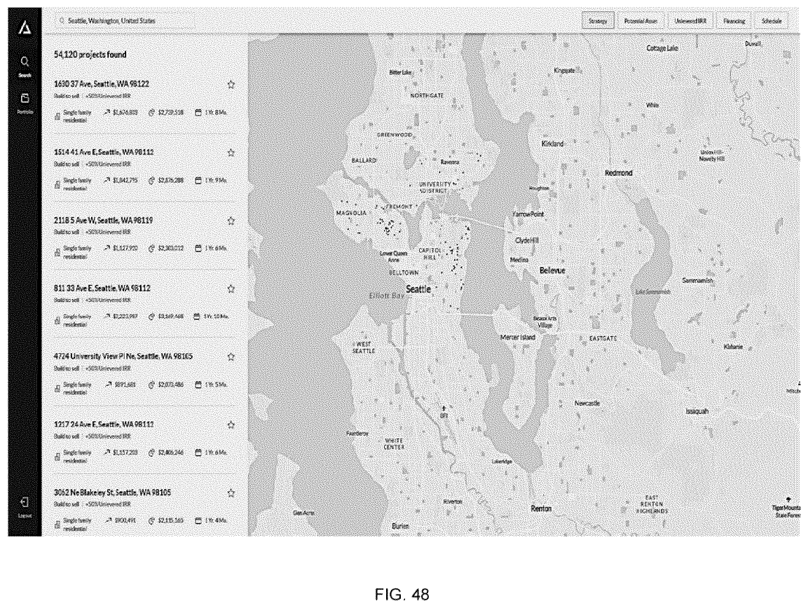

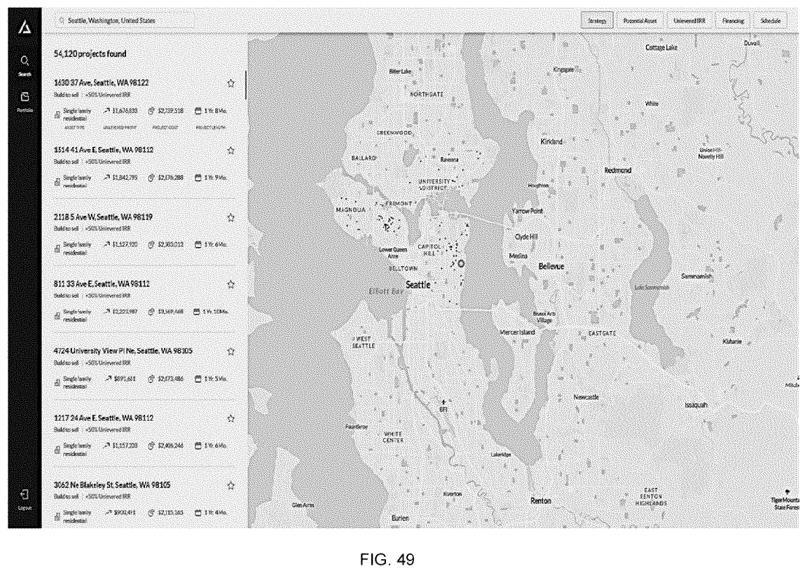

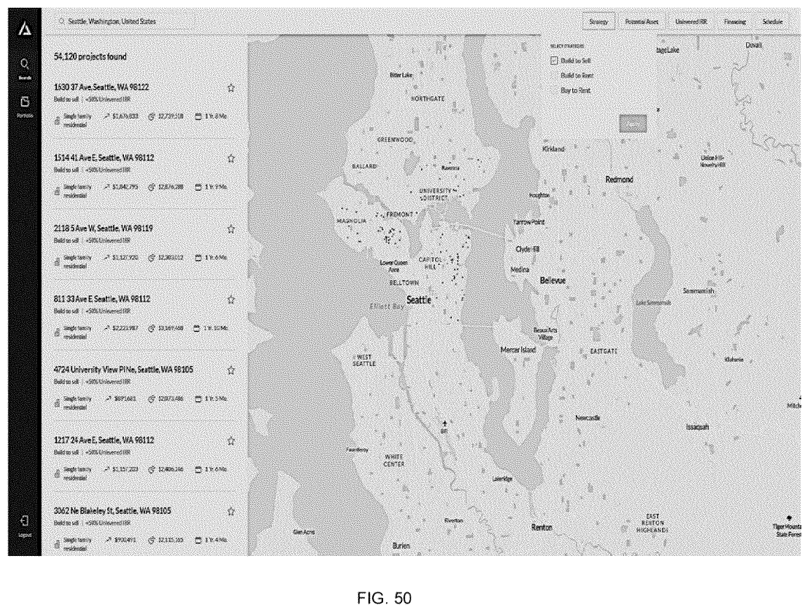

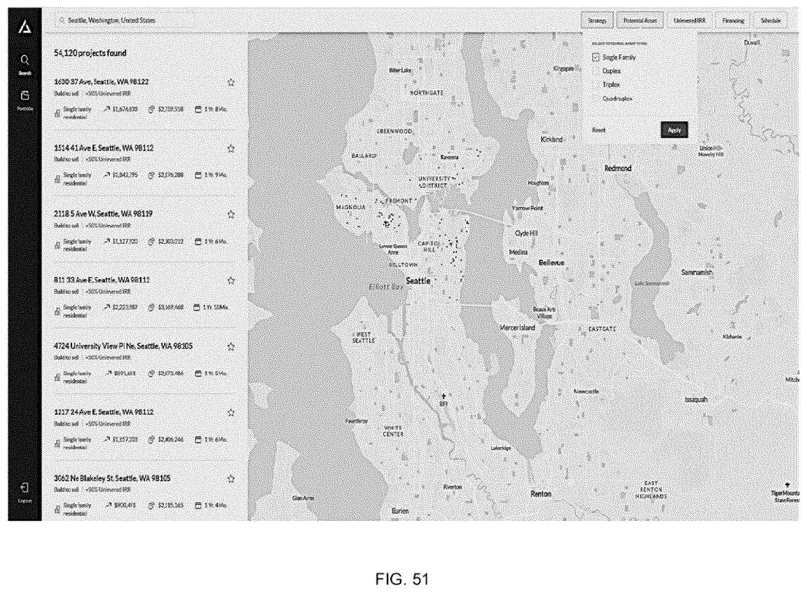

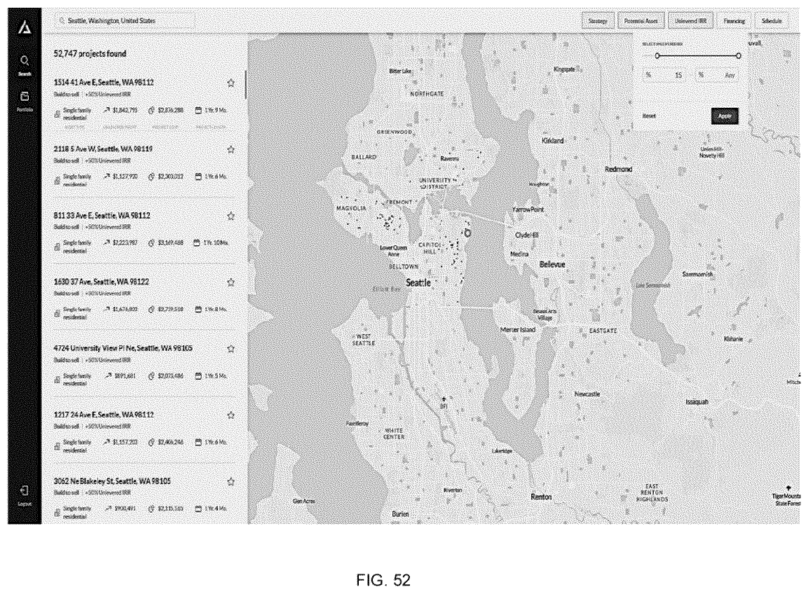

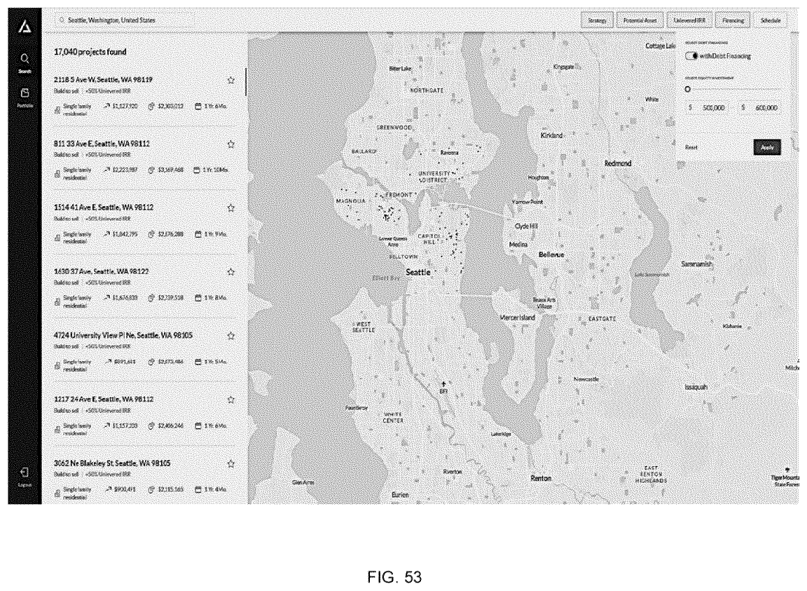

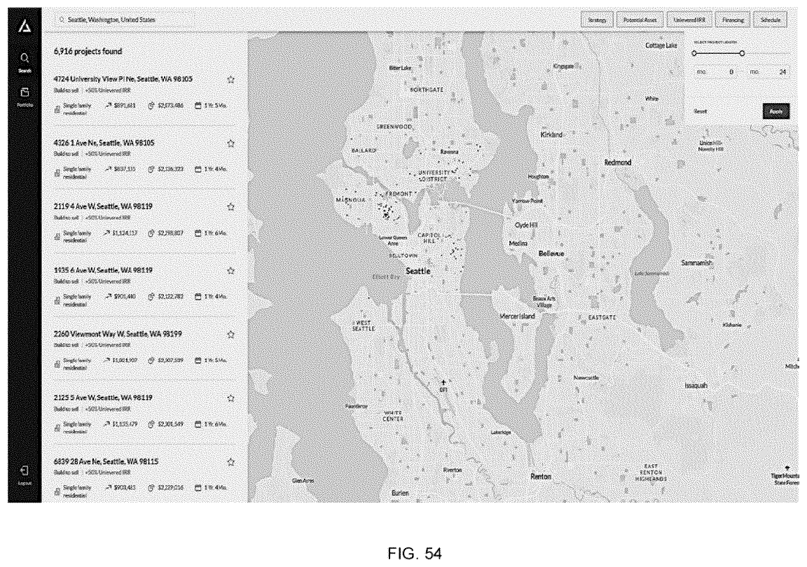

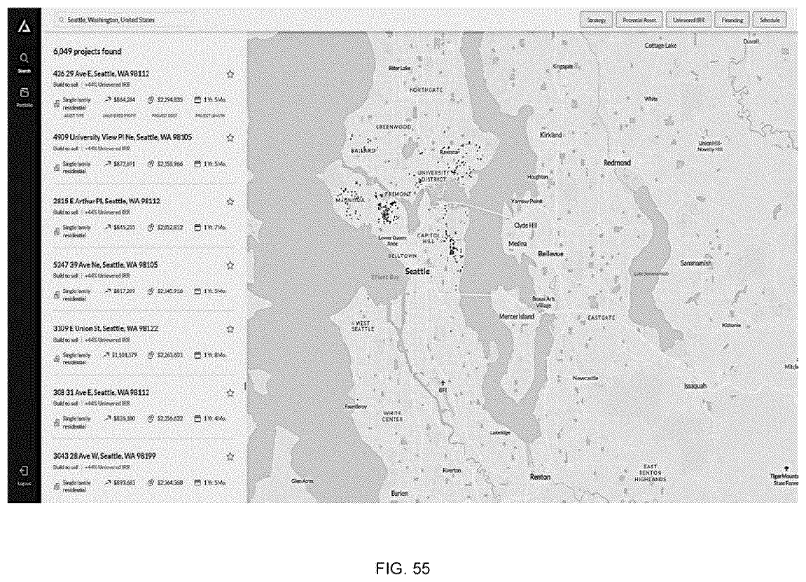

FIGS. 46 to 55 show front-end views in the Strategy menu. FIG. 46 shows a regional map view with properties indicated. FIG. 47 shows a regional map view with a drop down search box. FIG. 48 shows a map view of a specific geographic area requested in the search box. FIG. 49 shows a map view with a specific property highlighted. FIG. 50 shows a map view with a drop down strategy menu. FIG. 51 shows a map view with a drop down strategy menu of property types. FIG. 52 shows a map view with a drop down menu for selecting unlevered IRR. FIG. 53 shows a map view with a drop down menu for selecting financing parameters. FIG. 54 shows a map view with a drop down menu for selecting scheduling parameters for project length. FIG. 55 shows a map view with a property list after applying the filters selected in FIGS. 50-54.

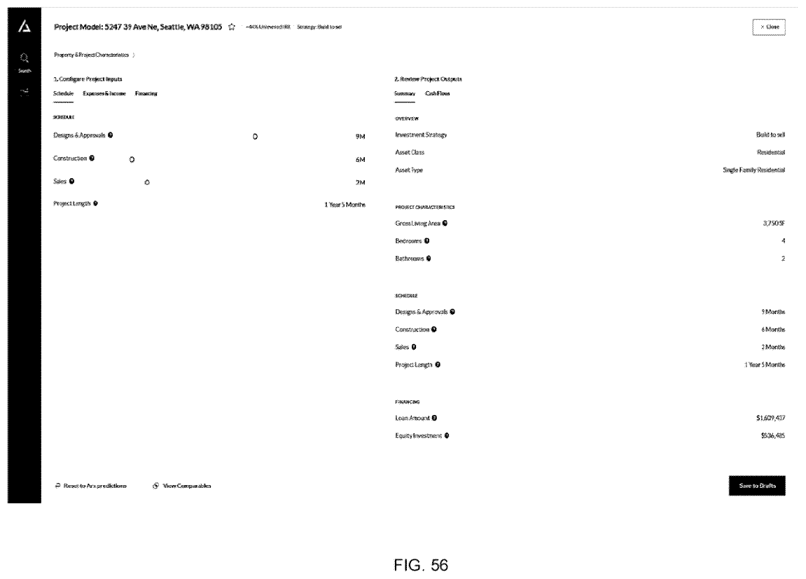

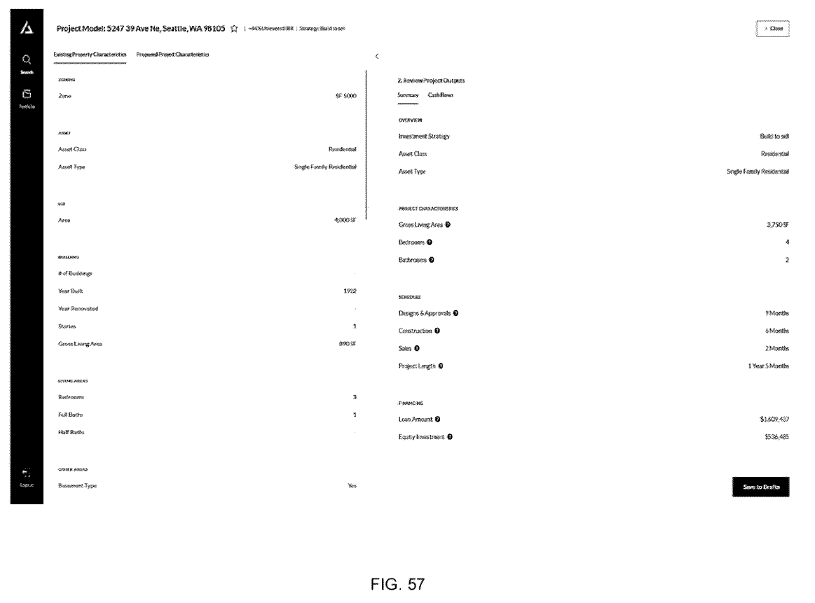

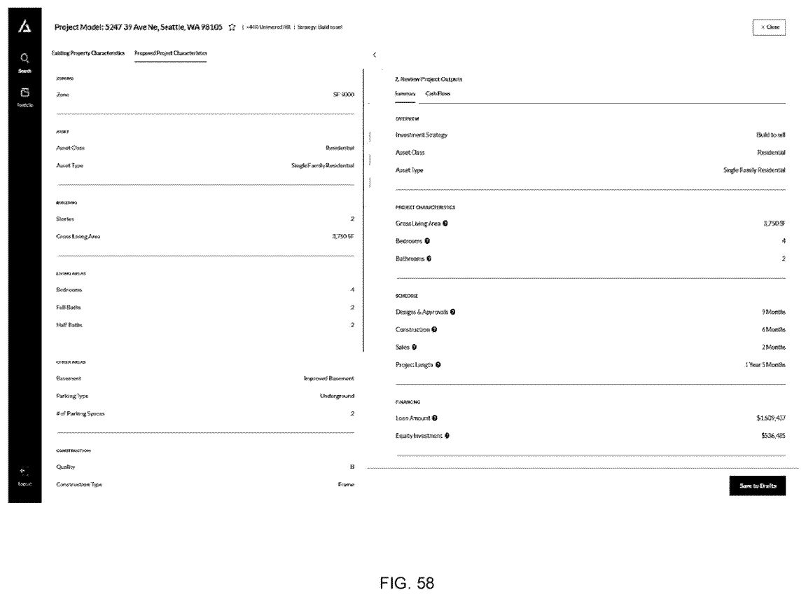

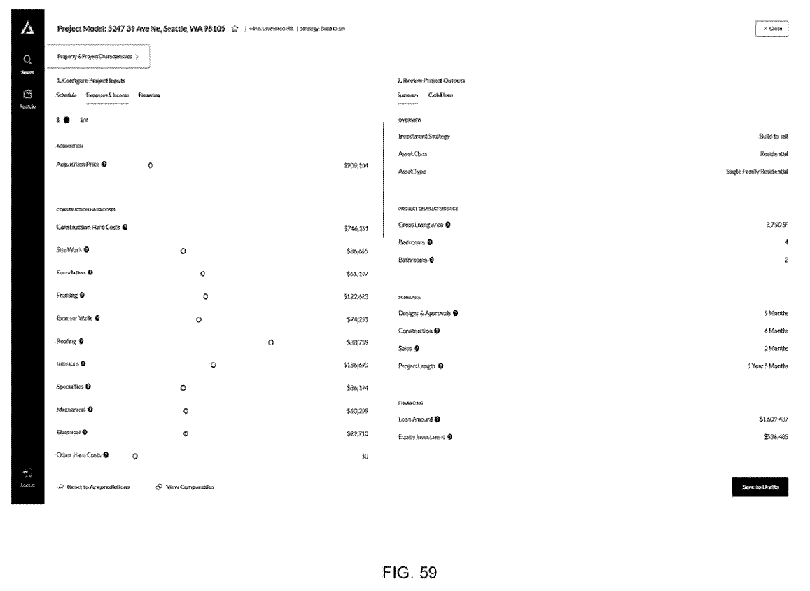

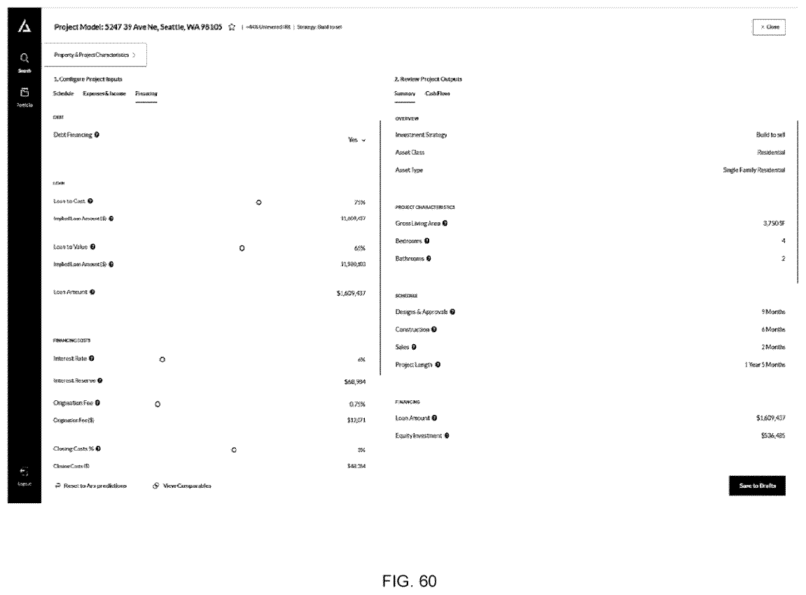

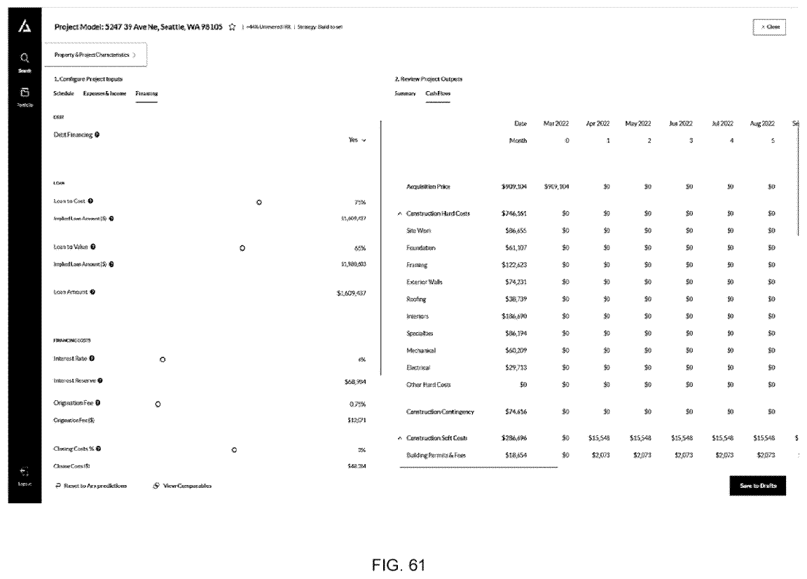

FIGS. 56 to 61 show front-end views in the Project Model module. FIG. 56 shows a Project Model summary view for a specific property. FIG. 57 shows a Project Model summary view for a specific property showing existing property characteristics. FIG. 58 shows a Project Model summary view for a specific property showing proposed project characteristics. FIG. 59 shows a Project Model summary view for a specific property showing an expenses and income summary. FIG. 60 shows a Project Model summary view for a specific property showing a financing summary. FIG. 61 shows a Project Model financing summary view for a specific property showing a cash flow schedule.

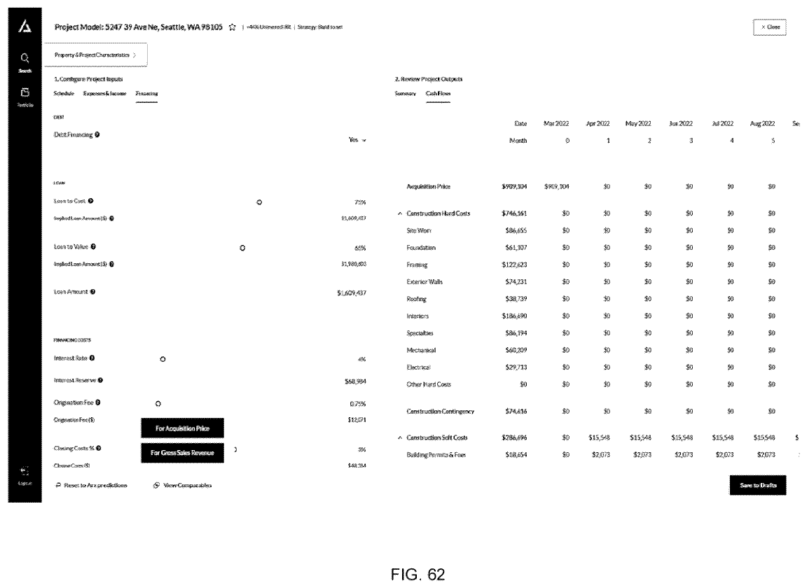

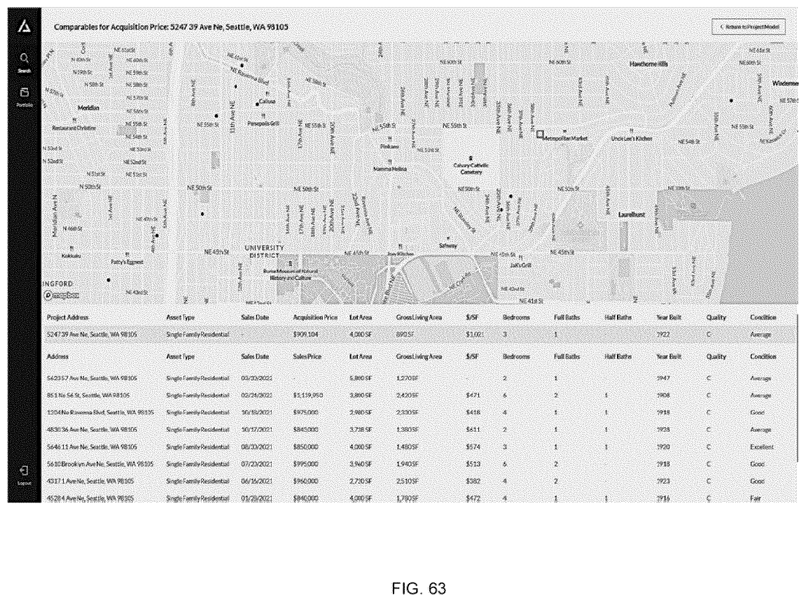

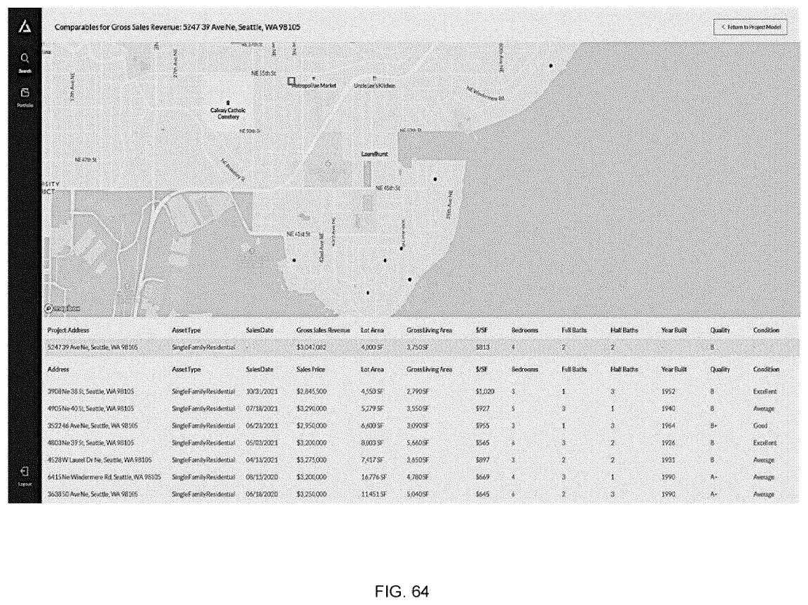

FIGS. 62 to 64 show front-end views of a Comparables module for searching comparable properties for a specific property. FIG. 62 shows a Project Model financing summary view for a specific property with a pop-up menu to view comparable transactions for either acquisition price or gross sales revenue. FIG. 63 shows a front-end view showing a list and map view of comparable properties for the acquisition price. FIG. 64 shows a front-end view showing a list and map view of comparable properties for the gross sales revenue.

The Comparables feature allows users to identify similar properties for both existing asset configurations as well as simulated new configurations, ultimately allowing users to view similar, past transactions that underpin the platform's predictions for acquisition price and gross sales revenue.

The Comparables algorithm calculates a similarity distance metric between the configuration under analysis (existing asset configuration for acquisition price; simulated new configuration for gross sales revenue) and previous property transactions within the same geography. The calculation is a measure of Euclidean distance, using a variety of variables as vectors (for example, gross living area, number of bedrooms, etc.) and weightings for vector importance. While the Comparables functionality is shown in the embodiment of FIGS. 62-64 for acquisition price and gross sales revenue, other comparable queries are also envisioned.

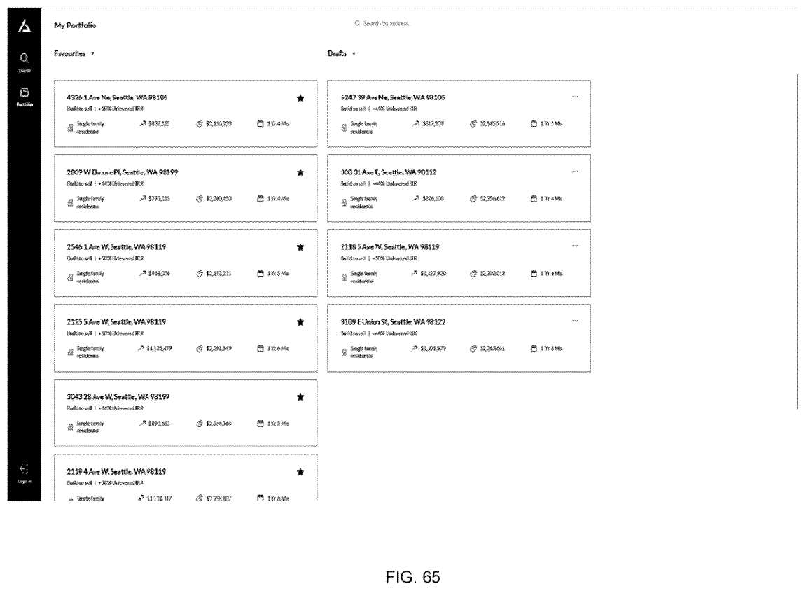

FIG. 65 shows a front-end view showing a summary of properties in a user's portfolio.

The frontend views, filters and screens used in the disclosed system described and shown above for FIGS. 9 through 66 are not limiting. Other frontend views, filters and screens may be envisioned, including for example, visual massings of existing properties and potential reconfigurations, maps of the different datasets and simulation outputs (heatmaps, point maps, distributions, etc).

1. A system comprising a computerized system with hardware and specialized software components for simulating a potential financial outcome for real property, the system comprising a non-transitory computer readable storage medium comprising a plurality of computer readable instructions embodied thereon which, when executed by the computerized system, causes the computerized system to:
determine existing property attributes for an existing property;
determine an acquisition value for the existing property based on existing property attributes; and
determine a potential financial outcome for the existing property based on existing property attributes and acquisition value.

2. The system of claim 1 wherein the computer readable instructions further cause the computerized system to
determine a potential reconfiguration of the existing property;
determine a potential value for the property based on the potential reconfiguration;
determine a conversion cost for converting the existing property to the potential reconfiguration;
determine a conversion timeline for converting the existing property to the potential reconfiguration; and
determine a potential financial outcome for the existing property based on existing property attributes and acquisition value, potential value after potential reconfiguration, conversion cost, and conversion timeline.

3. The system of claim 2 wherein a plurality of potential reconfigurations of the existing property are determined.

4. The system of claim 3 wherein conversion costs and conversion timelines for each of the plurality of potential reconfigurations are determined.

5. The system of claim 4 wherein potential financial outcomes are determined for the plurality of potential reconfigurations of the existing property based on existing property attributes and acquisition value, potential value after each potential reconfiguration, conversion costs and conversion timelines for each potential reconfiguration.

6. The system of claim 1 wherein the computer readable instructions further cause the computerized system to determine a potential financial outcome for each of a plurality of existing properties based on existing property attributes and acquisition values for each of the plurality of existing properties.

7. The system of claim 6 wherein a plurality of potential financial outcomes are determined for a plurality of potential reconfigurations of the plurality of existing properties based on existing property attributes and acquisition value, potential value after each potential reconfiguration, and conversion costs and conversion timelines for each potential reconfiguration.

8. The system of claim 1 further comprising a database configured to store at least one datum for the existing property selected from the group consisting of existing property attributes, acquisition value, potential reconfiguration, potential value, conversion cost, conversion timeline, and potential financial outcome.

9. The system of claim 8 wherein the database stores a plurality of financial outcomes for a plurality of potential reconfigurations of the existing property.

10. The system of claim 8 wherein the database stores at least one datum for a plurality of existing properties selected from the group consisting of existing property attributes, acquisition values, potential reconfigurations, potential values, conversion costs, conversion timelines, and potential financial outcomes.

11. The system of claim 8 further comprising a front-end interface configured to allow a user to search the database.

12. A non-transitory computer readable storage medium comprising a plurality of computer readable instructions embodied thereon wherein the instructions, when executed by a computerized system with hardware and specialized software components for simulating a potential financial outcome for real property, cause the computerized system to:
determine existing property attributes for an existing property;
determine an acquisition value for the existing property based on existing property attributes; and
determine a potential financial outcome for the existing property based on existing property attributes and acquisition value.

13. The non-transitory computer readable storage medium of claim 12 wherein the instructions further cause the computerized system to determine a potential reconfiguration of the existing property;
determine a potential value for the property based on the potential reconfiguration;
determine a conversion cost for converting the existing property to the potential reconfiguration;
determine a conversion timeline for converting the existing property to the potential reconfiguration; and
determine a potential financial outcome for the existing property based on existing property attributes and acquisition value, potential value after potential reconfiguration, conversion cost, and conversion timeline.

14. The non-transitory computer readable storage medium of claim 13 wherein the instructions further cause the computerized system to determine a plurality of potential reconfigurations of the existing property.

15. The non-transitory computer readable storage medium of claim 14 wherein the instructions further cause the computerized system to determine conversion costs and conversion timelines for each of the plurality of potential reconfigurations.

16. The non-transitory computer readable storage medium of claim 15 wherein the instructions further cause the computerized system to determine potential financial outcomes for the plurality of potential reconfigurations of the existing property based on existing property attributes and acquisition value, potential value after each potential reconfiguration, conversion costs and conversion timelines for each potential reconfiguration.

17. The non-transitory computer readable storage medium of claim 16 wherein the instructions further cause the computerized system to store a plurality of financial outcomes for a plurality of potential reconfigurations of the existing property.

18. The non-transitory computer readable storage medium of claim 12 wherein the computer readable instructions further cause the computerized system to determine a potential financial outcome for each of a plurality of existing properties based on existing property attributes and acquisition values for each of the plurality of existing properties.

19. The non-transitory computer readable storage medium of claim 18 wherein a plurality of potential financial outcomes are determined for a plurality of potential reconfigurations of the plurality of existing properties based on existing property attributes and acquisition value, potential value after each potential reconfiguration, and conversion costs and conversion timelines for each potential reconfiguration.

20. The non-transitory computer readable storage medium of claim 18 wherein the instructions further cause the computerized system to store at least one datum for a plurality of existing properties selected from the group consisting of existing property attributes, acquisition values, potential reconfigurations, potential values, conversion costs, conversion timelines, and potential financial outcomes.

21. A method for simulating a potential financial outcome for real property, executed by a processor of a computerized system comprising a processor and a database, the method comprising the processor:
determining existing property attributes for an existing property;
determining an acquisition value for the existing property based on existing property attributes; and
determining a potential financial outcome for the existing property based on existing property attributes and acquisition value.

22. The method of claim 21 further comprising determining a potential reconfiguration of the existing property;
determining a potential value for the property based on the potential reconfiguration;
determining a conversion cost for converting the existing property to the potential reconfiguration;
determining a conversion timeline for converting the existing property to the potential reconfiguration; and
determining a potential financial outcome for the existing property based on existing property attributes and acquisition value, potential value after potential reconfiguration, conversion cost, and conversion timeline.

23. The method of claim 21 further comprising the processor storing in the database at least one datum for the existing property selected from the group consisting of existing property attributes, acquisition value, potential reconfiguration, potential value, conversion cost, conversion timeline, and potential financial outcome.

24. The method of claim 22 further comprising the processor
determining a plurality of potential reconfigurations of the existing property;
determining conversion costs and conversion timelines for each of the plurality of potential reconfigurations and determining a plurality of potential financial outcomes for the plurality of potential reconfigurations of the existing property based on existing property attributes and acquisition value, potential value after each potential reconfiguration, conversion costs and conversion timelines for each potential reconfiguration.

25. The method of claim 24 further comprising the processor storing in a database the plurality of financial outcomes for the plurality of potential reconfigurations of the existing property.

26. The method of claim 21 further comprising the processor
determining existing property attributes for each of the plurality of existing properties;
determining acquisition values for each of the plurality of existing properties; and
determining a plurality of financial outcomes for the plurality of existing properties based on the existing property attributes and the acquisition values for each of the plurality of existing properties.

27. The method of claim 21 further comprising the processor determining a plurality of potential reconfigurations for each of the plurality of the existing properties;
determining conversion costs and conversion timelines for each of the plurality of potential reconfigurations; and
determining a plurality of potential financial outcomes for the plurality of potential reconfigurations of the plurality of existing properties based on existing property attributes and acquisition values, potential values after each potential reconfiguration, conversion costs and conversion timelines for each potential reconfiguration.

28. The method of claim 21 further comprising the processor storing at least one datum for the plurality of existing properties selected from the group consisting of existing property attributes, acquisition values, potential reconfigurations, potential values, conversion costs, conversion timelines, and potential financial outcomes.

29. A system comprising a distributed computerized system with hardware and specialized software components for simulating a potential financial outcome for real property, the system comprising a non-transitory computer readable storage medium comprising a plurality of computer readable instructions embodied thereon which, when executed by the computerized system, causes the computerized system to:
store information to a table comprising a first unique identifier (UID) corresponding to each of one or more existing properties in an existing configuration,
determine existing property attributes for each existing property in the existing configuration;
determine an acquisition value corresponding to the existing property in the existing configuration;
store to the table the existing the existing property attributes and the acquisition value associated with the first UID;
determine one or more potential reconfigurations of each existing property;
storing to the table a second UID corresponding to the one or more potential reconfigurations of the existing property, each second UID associated in the table with a first UID;
determining a reconfiguration value corresponding to each of the one or more reconfigurations;
store each reconfiguration value to the table associated with each second UID;
receive a real estate search request comprising an existing property and one more property attributes;
mapping the existing property to the first UID; and
generating search results from the table comprising all entries corresponding to the first UID.
